(19) United States
(12) Patent Application Publication
(10) Pub. No.: US 2016/0055319 A1
(43) Pub. Date: Feb. 25, 2016

(54) INTERACTIVE HEALTH MANAGEMENT APPARATUS, INTERACTIVE HEALTH MANAGEMENT METHOD, AND INTERACTIVE HEALTH MANAGEMENT PROGRAM

(71) Applicant: HITACHI, LTD., Tokyo (JP)

(72) Inventors: Kazuhiro IKEGAYA, Tokyo (JP); Takuya AKASHI, Tokyo (JP); Ryo FUKUMARU, Tokyo (JP); Yukinobu MARUYAMA, Tokyo (JP)

(21) Appl. No.: 14/780,075

(22) PCT Filed: Sep. 3, 2013
(86) PCT No.: PCT/JP2013/073694

§ 371 Date: Sep. 25, 2015

(30) Foreign Application Priority Data
Mar. 27, 2013 (JP) 2013-065344

(51) Int. Cl. G06F 19/00

(52) U.S. Cl. CPC G06F 19/3475; G06F 19/322

(57) ABSTRACT

An interactive health management apparatus is configured to: receive a category of a health value of a patient, a degree of improvement, priority orders between a period and a cost of the service; acquire a candidate medication based on an actual prescription; acquire a candidate service based on the received health value category and priority orders; displays the acquired candidate medication and a price thereof, and, the acquired candidate service and a fee thereof; calculate an estimated health value in the received health value category based on a degree of improvement of the candidate service and an actual past value of the health information; display the calculated estimated value as a time series graphic; and receive selection from the displayed candidate service by the patient.

### CROSS REFERENCE TO RELATED APPLICATION

This application is a National Stage Application of PCT/JP2013/073694, filed on Sep. 3, 2013, and which application is incorporated herein by reference. To the extent appropriate, a claim of priority is made to the above disclosed application.

### TECHNICAL FIELD

The present invention relates to an interactive health management apparatus, an interactive health management method, and an interactive health management program.

### BACKGROUND ART

A technique of facilitating communications on healthcare between a patient, a doctor, and the like has been widely utilized by making use of computers in recent years. For example, Japanese Laid-Open Patent Application, Publication No. H09-198446 discloses an interactive automatic questioning diagnostic device which performs steps of: receiving information on health of a patient represented by a numerical value; receiving information on a subjective symptom of the patient represented by non-numerical value; and outputting a health advice based on the health information and the subjective symptom. In the step of receiving the subjective symptom, the interactive automatic questioning diagnostic device displays a screen on which a whole body of the patient is displayed. When the patient specifies a site of the whole body, the interactive automatic questioning diagnostic device displays possible subjective symptoms at the specified site on the screen such that an appropriate choice can be made from among the displayed symptoms.

### RELATED ART DOCUMENT

### Patent Document

Patent Document 1: Japanese Laid-Open Patent Application, Publication No. H09-198446 (paragraph [0004])

### SUMMARY OF THE INVENTION

### Problem to be Solved by the Invention

When, for example, a householder of a family bears medical expenses of all members of the family, the householder may be greatly interested in comparing a medical effect and a cost paid for obtaining the medical effect; and successfully managing both maintenance of health of the family and soundness of a household finance. In addition to medical services offered by doctors and the like, there are a number of services offered by health-related service providers these days. Combination of those services may realize a target medical effect more efficiently. The householder may naturally assume important stages of life of the family members, for example, when a child enters elementary school, and may consider that the family members use which service at which cost and that how much medical effect is then expected between a present time and the important stage.

The interactive automatic questioning diagnostic device disclosed in Japanese Laid-Open Patent Application, Publication No. H09-198446 does not assume viewpoints as a usage of a service, soundness of a household finance for a whole family, a period until a target is achieved. Thus, in order to sufficiently meet needs of the householder, another measure is required.

In light of the described above, the present invention has been made in an attempt to provide an interactive health management apparatus that is configured to display a candidate service with its contents, effect, and cost during a target period and also display an already-used cost of the whole family.

### Means for Solving the Problem

An interactive health management apparatus is configured to: receive a category of a health value of a patient, a degree of improvement, priority orders between a period and a cost of the service; acquire a candidate medication based on an actual prescription; acquire a candidate service based on the received health value category and priority order; displays the acquired candidate medication and a price thereof, and the acquired candidate service and a fee thereof; calculate an estimated health value in the received health value category based on a degree of improvement of the candidate service and an actual past value of the health information; display the calculated estimated value as a time series graphic; and receive selection from the displayed candidate service by the patient.

Other means will be described in an embodiment for carrying out the present invention.

### Advantageous Effects of the Invention

In an aspect of the present invention, an interactive health management apparatus can be provided which displays contents, an effect, and a cost of a candidate service in a target period and also displays a target amount paid for services for each of all family members.

### BRIEF DESCRIPTION OF THE DRAWINGS

FIG. 1 is a configuration diagram illustrating a health management system according to an embodiment of the present invention.

FIG. 2 is each a configuration diagram illustrating an interactive health management apparatus, a patient terminal apparatus, and an agent terminal apparatus according to the embodiment.

FIG. 3 is a diagram illustrating an example of family information according to the embodiment.

FIG. 4 is a diagram illustrating an example of health information according to the embodiment.

FIG. 5 is a diagram illustrating an example of medication information according to the embodiment.

FIG. 6 is a diagram illustrating an example of service information according to the embodiment.

FIG. 7 is a diagram illustrating an example of family payment information according to the embodiment.

FIG. 8 is a diagram illustrating an example of a setting screen according to the embodiment.

FIG. 9 is a diagram illustrating an example of an interactive screen for agent according to the embodiment.

FIG. 10 is a diagram illustrating an example of an interactive screen for patient according to the embodiment.

FIG. 11 is a diagram illustrating another example of the interactive screen for agent according to the embodiment.

FIG. 12 is a diagram illustrating another example of the interactive screen for patient according to the embodiment.

FIG. 13 is a diagram illustrating an example of a time series graph of health values according to the embodiment.

FIG. 14 is a diagram illustrating an example of a service display screen according to the embodiment.

FIG. 15 is a diagram illustrating an example of a family payment screen according to the embodiment.

FIG. 16 is a flowchart illustrating a processing procedure according to the embodiment.

FIG. 17 is a continuation of the processing procedure of FIG. 16 according to the embodiment.

FIGS. 18A and 18C, and FIGS. 18B and 18D are transition diagrams of the interactive screen for agent and the interactive screen for patient, respectively, according to the embodiment.

FIGS. 19A and 19C, and FIGS. 19B and 19D are continuations of the transition diagrams of the interactive screen for agent and the interactive screen for patient, respectively, according to the embodiment.

FIG. 20 is a diagram illustrating an example of an entry on a screen according to the embodiment.

FIG. 21 is a diagram illustrating another example of an entry on a screen according to the embodiment.

### EMBODIMENT FOR CARRYING OUT THE INVENTION

An embodiment for carrying out the present invention (which may also be referred to as “this embodiment”) is described with reference to related drawings. In this embodiment, the following is assumed. There is a family of four persons, a husband (a salaried worker), a wife (a homemaker), a first son (an elementary school student), and a first daughter (a baby). The husband receives healthcare guidance from an industrial doctor of his workplace in many cases. The wife receives healthcare guidance from a family doctor in many cases. The first son (or his parent) receives healthcare guidance from a school doctor of his elementary school in many cases. The first daughter (or her parent) receives healthcare guidance from a childminder of her childcare center in many cases.

Let a “supporter” be referred to as a collective term of healthcare professionals such as an industrial doctor, a family doctor, a pharmacist, a school doctor, and a childminder. Meanwhile, let an “agent” be referred to as an expert who gives healthcare guidance such as cost analysis of medical expenses from an economical and/or a household management viewpoint, to a group related to a patient such as a family of the patient. Insurance companies and the like can collect a lot of information on healthcare offered from health-related service providers. The agent is capable of explaining contents of healthcare services to a patient in an easily understandable way. It is convenient for a householder such as, for example, a husband, to get advice from an agent independent from a supporter and to review treatment policy or the like of his family from the economical and household management viewpoint.

### <System Configuration>

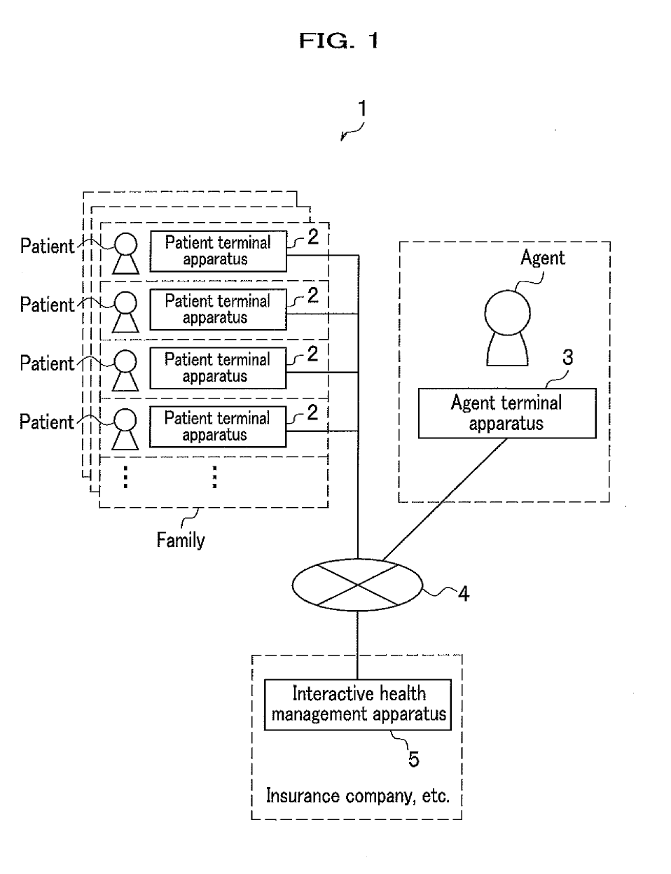

Next is described a configuration of a health management system 1 with reference to FIG. 1. The health management system 1 includes a patient terminal apparatus 2, an agent terminal apparatus 3, and an interactive health management apparatus 5, which are connected each other via a network 4. The patient terminal apparatus 2 and the agent terminal apparatus 3 receive entries from a patient who belongs to a family, and an agent, respectively. The interactive health management apparatus 5 is installed at an insurance company, for example.

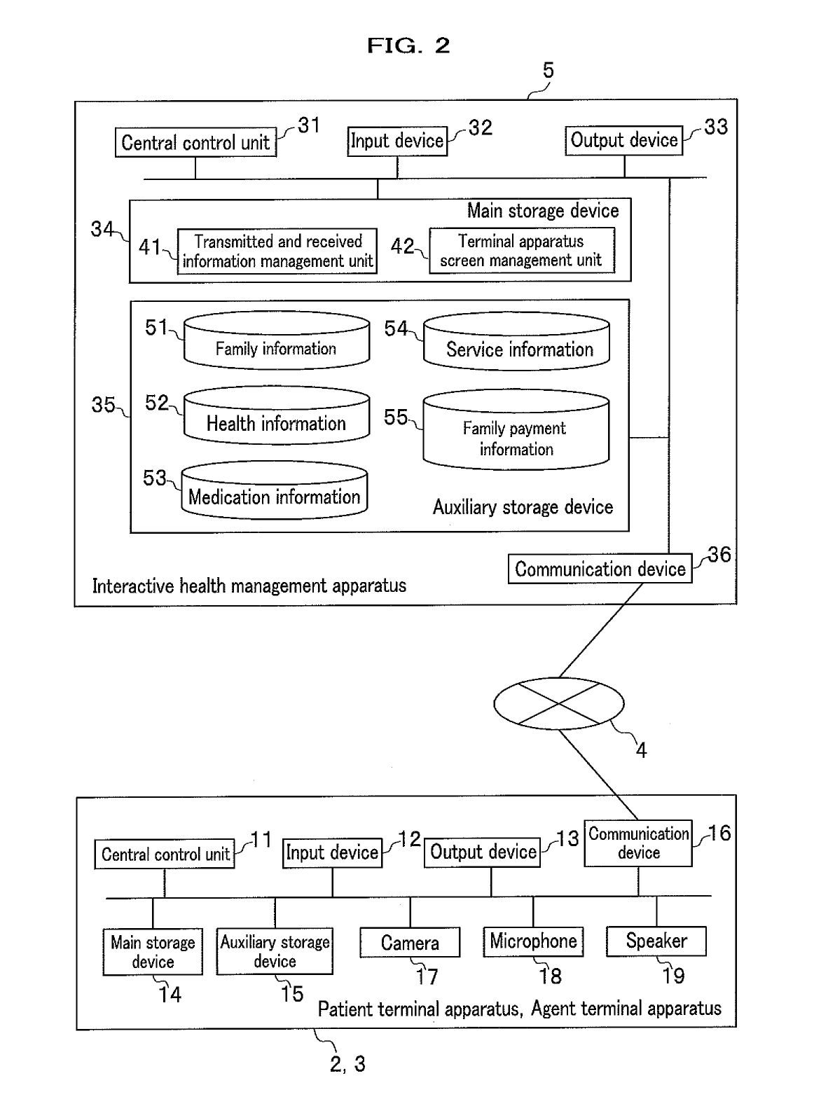

Next are described configurations of the patient terminal apparatus 2 and the agent terminal apparatus 3 with reference to FIG. 2. The patient terminal apparatus 2 is embodied by a generally available computer. The patient terminal apparatus 2 includes a central control unit 11, an input device 12 such as a keyboard, a mouse, and a touch screen, an output device 13 such as a display, a main storage device 14, an auxiliary storage device 15, a communication device 16, a camera 17, a microphone 18, and a speaker 19, which are connected each other via a system bus.

Detailed descriptions on the components 11 to 16, which constitute a generally available computer, are omitted herefrom. The camera 17 captures a (still or moving) image of a patient as an object. The microphone 18 acquires speech of the patient. The speaker 19 reproduces speech of an agent.

The agent terminal apparatus 3 is also embodied by a generally available computer. The description above on the configuration of the patient terminal apparatus 2 is applied to the agent terminal apparatus 3 except that: a camera 17 of the agent terminal apparatus 3 captures an image of the agent as an object; a microphone 18 thereof acquires speech of the agent; and a speaker 19 thereof reproduces speech of the patient.

The interactive health management apparatus 5 is also embodied by a generally available computer. The interactive health management apparatus 5 includes a central control unit 31, an input device 32, an output device 33, a main storage device 34, an auxiliary storage device 35, and a communication device 36, which are connected each other via a system bus.

Detailed descriptions on the components 31 to 36, which constitute a generally available computer, are omitted herefrom.

A transmitted and received information management unit 41 and a terminal apparatus screen management unit 42 of the main storage device 34 are each a program. To simplify description, the components 41 and 42 are herein assumed to directly perform their respective functions (to be described in detail hereinafter). It is, however, the central control unit 11 that actually performs the functions of the programs after reading out and loading the programs from the auxiliary storage unit 35 into the main storage unit 34. The auxiliary storage device 35 stores therein family information 51, health information 52, medication information 53, service information 54, and family payment information 55, details of which will be described hereinafter.

### <Family Information>

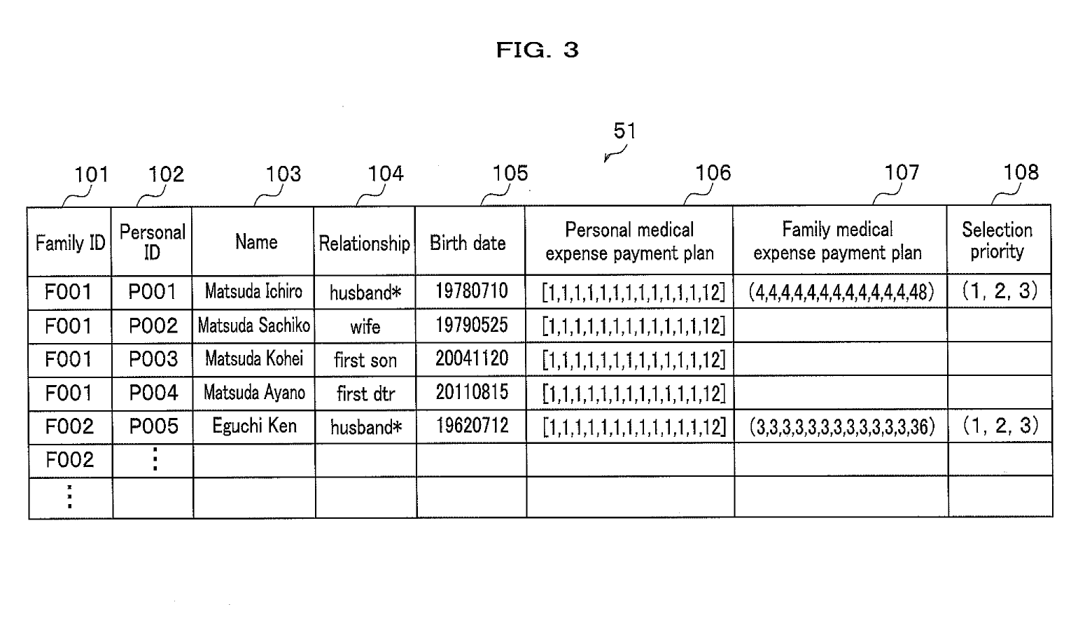

Next is described the family information 51 with reference to FIG. 3. The family information 51 includes a family ID which is stored in a family ID column 101. In association with the family ID, the family information 51 also includes: a personal ID as an ID of a person as a member of the family, in a personal ID column 102; a name of the person, in a name column 103; a relationship of the person in the family, in a relationship column 104; a birth date of the person, in a birth date column 105; a personal medical expense payment plan 106, in a personal medical expense payment plan column 106; a family medical expense payment plan, in a personal medical expense payment plan column 107; and a selection priority, in a selection priority column 108.

The family ID in the family ID column 101 is an identifier for uniquely identifying a family to which a patient belongs.

The personal ID in the personal ID column 102 is an identifier for uniquely identifying the patient.

The name in the name column 103 is a name of the patient.

The relationship in the relationship column 104 indicates a relationship of the patient in the family. Examples of the relationship such as “husband”, “wife”, “first son”, and “first daughter” are provided herein. Another examples of the relationship include, for example, “second son”, “second daughter”, “mother of husband”, and “first son of first son”. Note that if the relationship of a person has a sign “*”, the person is a representative of his/her family (one representative per family).

The birth date in the birth date column 105 is a birth date of the patient.

The personal medical expense payment plan in the personal medical expense payment plan column 106 shows an amount (unit: ten thousand yen) to be paid for medical or other services for the patient. The personal medical expense payment plan contains 13 numerical values between which are delimited with “,”. The value positioned first indicates a monthly budget for January in a given year; the value positioned second, for February; . . . ; and the value positioned twelfth, for December. The value positioned last indicates an annual budget for the year (a total sum of the monthly budgets).

The family medical expense payment plan in the family medical expense payment plan column 107 shows an amount (unit: ten thousand yen) to be paid for medical or other services for the whole family. The family medical expense payment plan also contains 13 numerical values between which are delimited with “,”. The 13 values are similar to those of the personal medical expense payment plan. The amount of the family medical expense payment plan is calculated by adding up the amounts of the personal medical expense payment plans of all members of the family of interest, as will be understood. The family medical expense payment plan is stored only in a record of which relationship is given “*”.

The selection priority in the selection priority column 108 shows information on priority orders of three measures for evaluating a service. The three measures for evaluating the service are a cost, an effect (a degree of improvement), and an effective use period for reference after which the effect can be obtained. Let us assume a case where the selection priority is “cost, period, effect=(1, 2, 3)”. This means that a service is selected: firstly, in ascending order of the cost; secondly, in ascending order of the effective use period for reference; and, lastly, in descending order of the effect. In FIG. 3, the selection priority is stored only in a record of which relationship is given “*”. The selection priority may be alternatively stored in all records. This allows an individual patient of the family to be provided with a well targeted service.

The number of records of the family information 51 is as much as the number of the personal IDs. For example, as shown in rows 1 to 4 of FIG. 3, a family having the family ID “F001” has four family members, namely, “Matsuda Ichiro” who is a “husband” and a representative; “Matsuda Sachiko” who is a “wife”; “Matsuda Kohei” who is a “first son”; and “Matsuda Ayano” who is a “first daughter”.

### <Health Information>

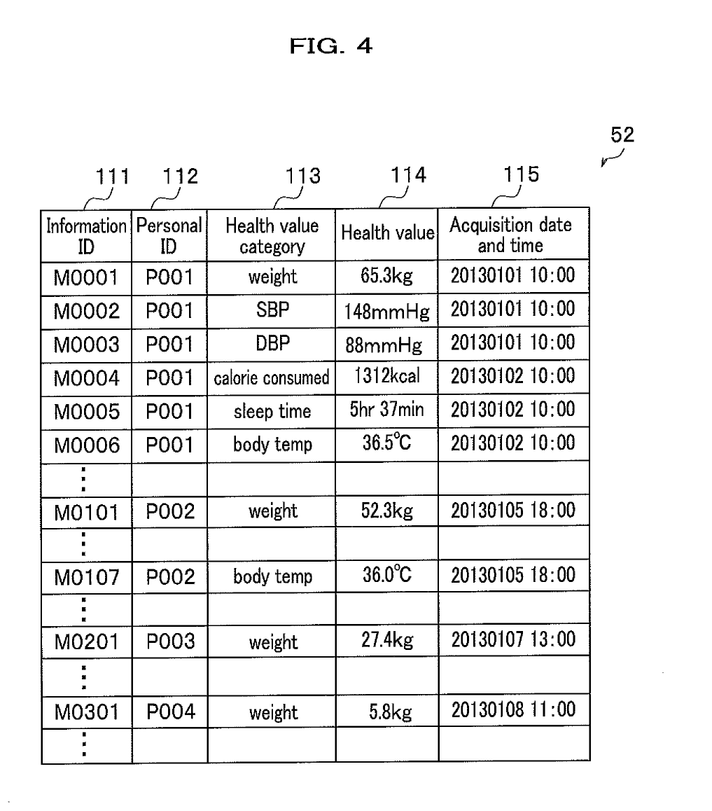

Next is described the health information 52 with reference to FIG. 4. The health information 52 includes an information ID which is stored in an information ID column 111. In association with the information ID, the health information 52 also includes: a personal ID in a personal ID column 112; a health value category in a health value category column 113; a health value in a health value column 114; and an acquisition date and time of the health value 114 in an acquisition date and time column 115.

The information ID in the information ID column 111 is an identifier for uniquely identifying a record in the health information 52.

The personal ID in the personal ID column 112 is same as the personal ID in FIG. 3.

Before explaining the health value category column 113, the “health value” is described next.

The health value used herein is quantitative information on a human body such as, for example:
a height, a weight, a body temperature, a systolic blood pressure (SBP), a diastolic blood pressure (DBP), and a pulse rate which are information directly acquirable by using measuring instruments;
a blood sugar level which is information acquirable by analyzing a sample taken from the body;
a time of a 50-meter dash which is information on athletic performance; and
a sleep time and a calorie consumed which are information acquirable by adding up values on daily behavior.

The health value category in the health value category column 113 refers to types of the health value and includes herein, as an example, “weight”, “systolic blood pressure”, “diastolic blood pressure”, “body temperature”, “calories consumed”, and “sleep time”. Another examples of the health value category include “height”, “pulse rate”, and “blood sugar level”.

The health value in the health value column 114 is a health value acquired from a person of interest.

The acquisition date and time in the acquisition date and time column 115 is a year, a month, a day, and a time at which the health value was acquired. The number of records of the health information 52 is as much as the number of the health values acquired from a beginning of the year to date.

As shown in rows 1 to 3 of FIG. 4, for example, information as follows can be obtained:
Matsuda Ichiro weighed 65.3 kg at 10:00 on Jan. 1, 2013.
Matsuda Ichiro had the systolic blood pressure of “148 mmHg” and the diastolic blood pressure of “88 mmHg” at the date and time.

### <Medication Information>

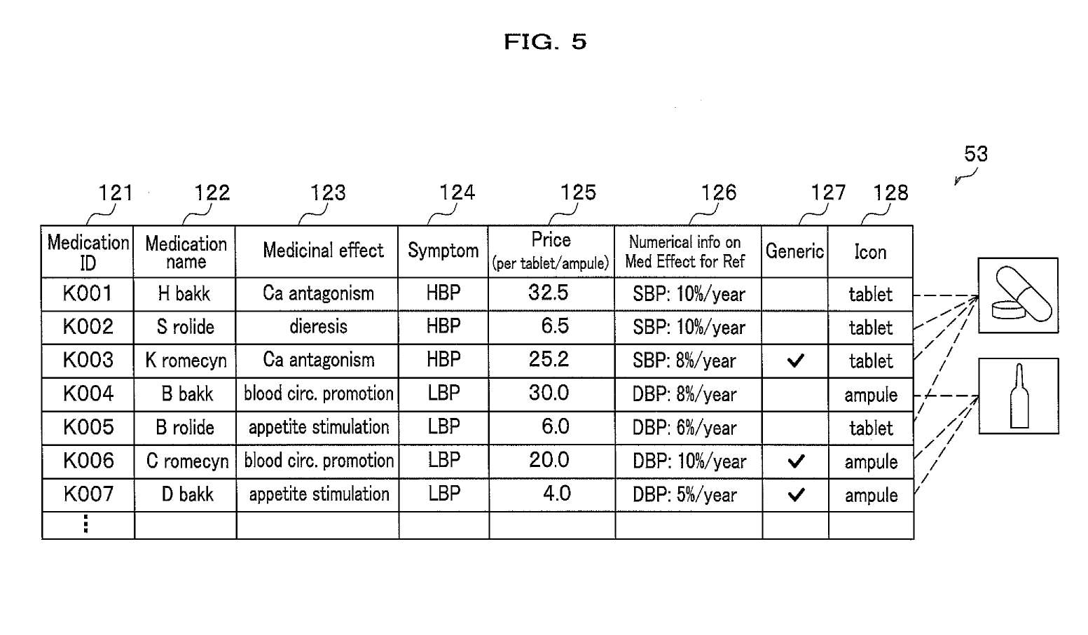

Next is described the medication information 53 with reference to FIG. 5. The medication information 53 includes a medication ID which is stored in a medication ID column 121. In association with the medication ID, the medication information 53 also includes: a medication name in a medication name column 122; a medicinal effect in a medicinal effect column 123; a symptom in a symptom column 124; a price in a price column 125; numerical information on medication effect for reference in a numerical information on medication effect for reference column 126; an off-patent flag in a generic column 127; and an icon in an icon column 128.

Note that the interactive health management apparatus 5 obtains the medication information 53 from an appropriate supporter or receives control on the medication information 53 from an appropriate supporter.

The medication ID in the medication ID column 121 is an identifier for uniquely identifying the medication.

The medication name in the medication name column 122 is a name of the medication.

The medicinal effect in the medicinal effect column 123 is an effect which the medication causes on a patient.

The symptom in the symptom column 124 is a failure of health in the patient.

The price in the price column 125 is a unit price of the medication. The unit price is, for example, if the medication is in tablet form, a price per tablet (unit: yen). If the medication is in liquid form, the price is a price per ampule.

The numerical information on medication effect for reference in the numerical information on medication effect for reference column 126 is a combination of a health value category and a ratio of improvement and is described as, for example, “systolic blood pressure: 10%/year”. In this example, the health value category is “systolic blood pressure” and the ratio of improvement is “10%/year”. The “systolic blood pressure: 10%/year” means that it is statistically demonstrated that the patient can have a 10% decrease in his/her systolic blood pressure after application of the medication for one year. Similarly, “diastolic blood pressure: 8%/year” means that it is statistically demonstrated that the patient can have a 8% increase in his/her diastolic blood pressure after application of the medication for one year. Note that the ratio of improvement described by a percentage can be replaced by a value of improvement described by an actual numeral such as, for example, “diastolic blood pressure: +5 mmHg/year”. The “degree of improvement” is a concept containing both the ratio of improvement and the value of improvement.

The off-patent flag in the generic column 127 is a flag indicating that duration of a patent of the medication has been completed. A sign “✓” used herein indicates that the off-patent flag is ON.

The icon in the icon column 128 represents a type of a pictorial figure when the medication is displayed on a screen.

### <Service Information>

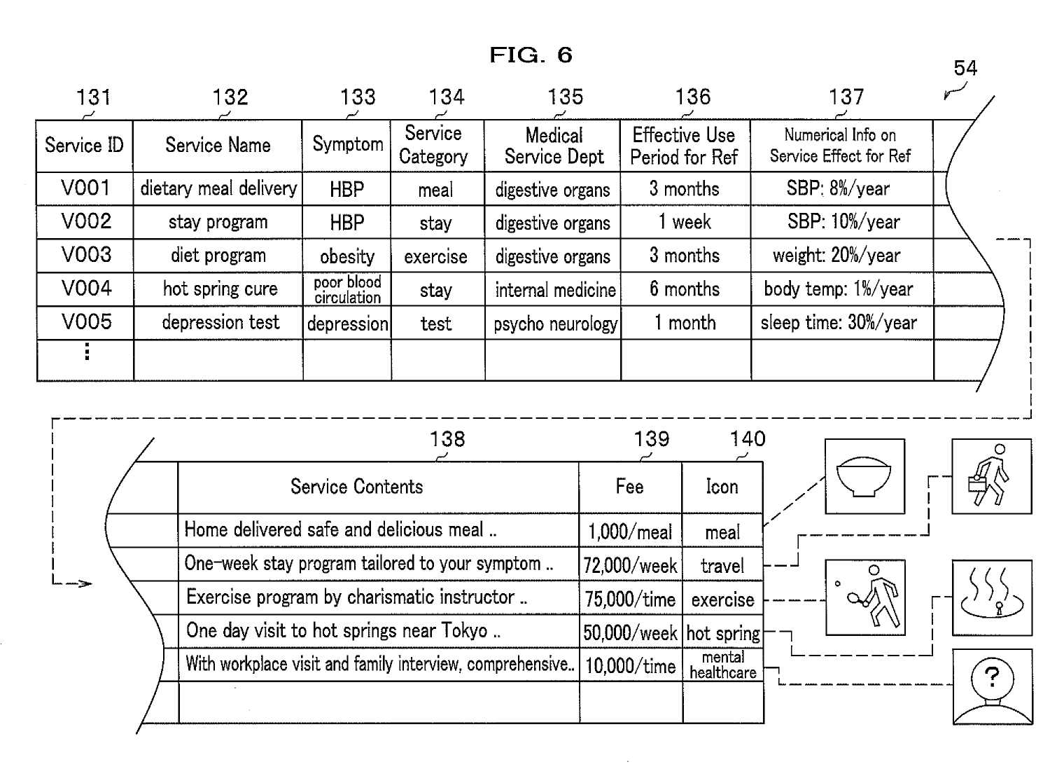

Next is described the service information 54 with reference to FIG. 6. The service information 54 includes a service ID which is stored in a service ID column 131. In association with the service ID, the service information 54 also includes: a service name in a service name column 132; a symptom in a symptom column 133; a service category in a service category column 134; a medical service department in a medical service department column 135; an effective use period for reference in an effective use period for reference column 136; numerical information on service effect for reference in a numerical information on service effect for reference column 137; service contents in a service contents column 138; a fee in a fee column 139; and an icon in an icon column 140. Note that the service information 54 of FIG. 6 is illustrated in a two tiered layout, though actually not being divided.

The service ID in the service ID column 131 is an identifier for uniquely identifying a service. As described above, the service herein means a service provided by a health-related service provider other than a supporter. In the broadest meaning, the service includes sales of a product by such a health-related service provider.

The service name in the service name column 132 is a name of the service.

The symptom in the symptom column 133 is same as the symptom in FIG. 5.

The service category in the service category 134 is a type of the service. The service category includes, for example, “diet”, “stay”, and “exercise”.

The medical service department in the medical service department column 135 refers to a specialized field of a supporter related to the service.

The effective use period for reference in the effective use period for reference column 136 refers to a minimum period during which the patient should use the service without interruption so as to have an effect (“a degree of improvement”) of the service. The period may also be referred to as “a period of the service after which an effect of the service is expected”.

The numerical information on service effect for reference in the numerical information on service effect for reference column 137 is a combination of the health value category and the ratio of improvement and is described as, for example, “systolic blood pressure: 10%/year”. In this example, the health value category is “systolic blood pressure” and the ratio of improvement is “10%/year”. The health value category and the ratio of improvement mean similarly to those explained above in the numerical information on medication effect for reference. Also similarly to the numerical information on medication effect for reference, note that: the ratio of improvement described by a percentage can be replaced by a value of improvement described by an actual numeral; and that a concept containing both the ratio of improvement and the value of improvement is referred to as the “degree of improvement”.

The service contents in the service contents column 138 are text for explaining contents of the service to the patient in concrete terms.

The fee in the fee column 139 is a fee or a price (unit: yen) of the service.

The icon in the icon column 140 represents a type of a pictorial figure when the medication is displayed on a screen.

### <Patient Family Payment Information>

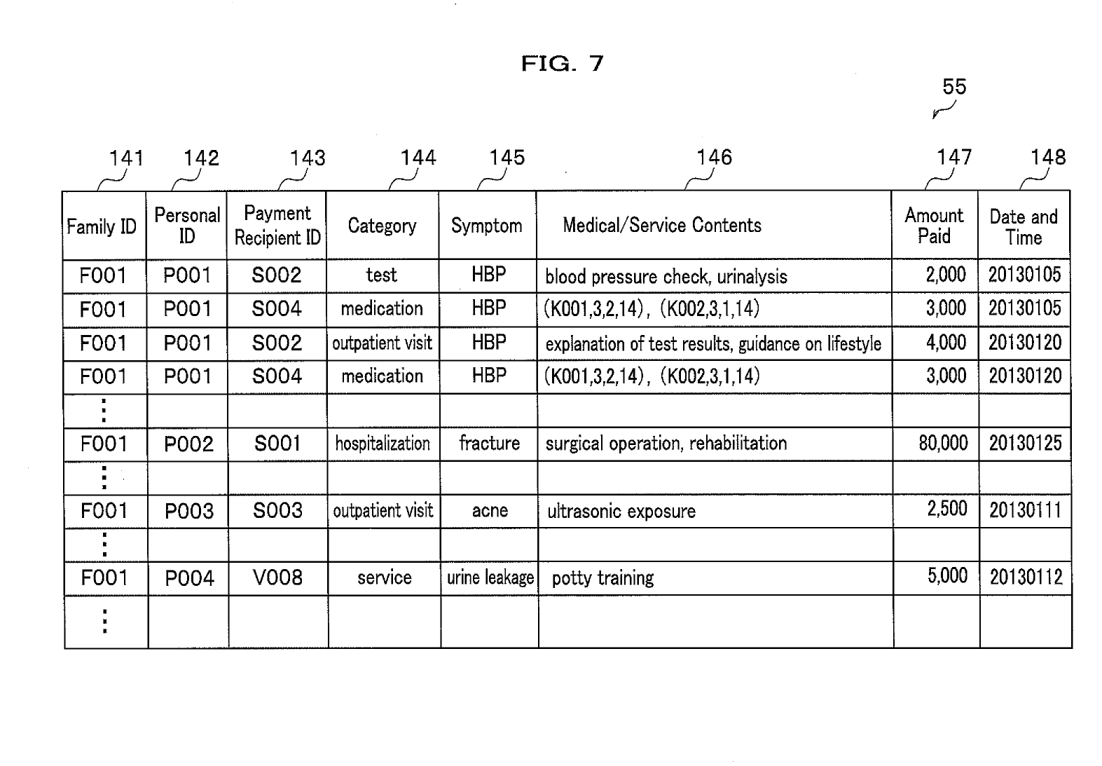

Next is described the family payment information 55 with reference to FIG. 7. The family payment information 55 includes a family ID which is stored in a family ID column 141. In association with the family ID, the family payment information 55 includes: a personal ID in a personal ID column 142; a payment recipient ID in a payment recipient ID column 143; a category in a category column 144; a symptom in a symptom column 145; medical/service contents in a medical/service contents column 146; an amount paid in an amount paid column 147; and a date and time in a date and time column 148.

The family ID in the family ID column 141 is same as the family ID in FIG. 3.

The personal ID in the personal ID column 142 is same as the personal ID in FIG. 3.

The payment recipient ID in the payment recipient ID column 143 is an identifier for uniquely identifying a payment recipient. If the payment recipient is a supporter, the payment recipient ID uniquely identifies the supporter, which is also used as a supporter ID. If the payment recipient is a health-related service provider, the payment recipient ID is also used as the service ID.

The category in the category column 144 refers to a category of medical or other services provided by the payment recipient. Some medical categories in which the supporter is directly involved include “test”, “medication”, “outpatient visit”, and “hospitalization”. The health-related service provider actually offers a wide variety of services without direct involvement of the supporter, which is, however, put into just one category, “service”.

The symptom in the symptom column 145 is same as the symptom in FIG. 5.

The medical/service contents in the medical/service contents column 146 are detailed contents of medical or other service to which the payment of interest is made. The service contents in a case where, for example, the category is “medication” are described as “(K001, 3, 2, 14)”. This means that a medication having the medication ID of “K001” is prescribed to be taken three times a day as two tablets for 14 days.

The amount paid in the amount paid column 147 is an amount (unit: yen) which the patient paid to the supporter or the like.

The date and time in the date and time column 148 is a year, a month, and a day when the payment is made.

The number of records in FIG. 7 is as much as the number of times of the payment made starting from a beginning of the year (as exemplified in the figure, Jan. 1, 2013) to date.

Description on display screens and processing procedures is made below.

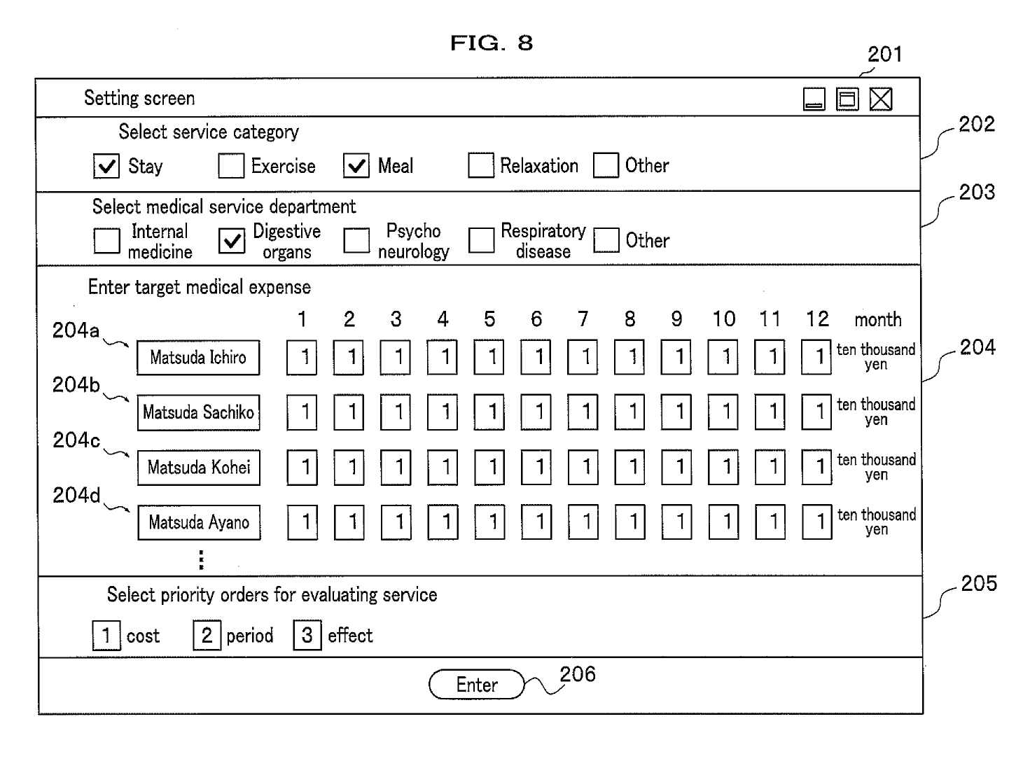

A setting screen 201 is described with reference to FIG. 8. The setting screen 201 includes a service category selection field 202, a medical service department selection field 203, a medical expense payment schedule entry field 204, a selection priority entry field 205, and an “Enter” button 206. As described above, services are classified by category (diet, stay, exercise, and the like). A patient or an agent checks an appropriate checkbox in the service category selection field 202. This makes the terminal apparatus screen management unit 42 narrow down candidate services to be displayed on the setting screen 201.

The patient checks an appropriate checkbox in the medical service department selection field 203. This makes the terminal apparatus screen management unit 42 narrow down candidate services to be displayed on the setting screen 201.

The patient enters a name of his/her family member and a monthly payment budget into an appropriate row in rows 204a to 204d in the medical expense payment schedule entry field 204. Or, any other family member may enter appropriate data on behalf of the family.

The patient enters the selection priority as described above in the selection priority entry field 205. More specifically, the patient enters respective priority orders in “cost”, “period”, and “effect” columns in the selection priority entry field 205. Assume a case where the patient enters (cost, period, effect)=(1, 2, 3). This means that the patient wants to select a service: firstly in ascending order of the cost; secondly, in ascending order of the effective use period for reference, if a plurality of services tie with an equal cost; and, lastly, in descending order of the degree of improvement, if a plurality of services tie with an equal effective use period for reference.

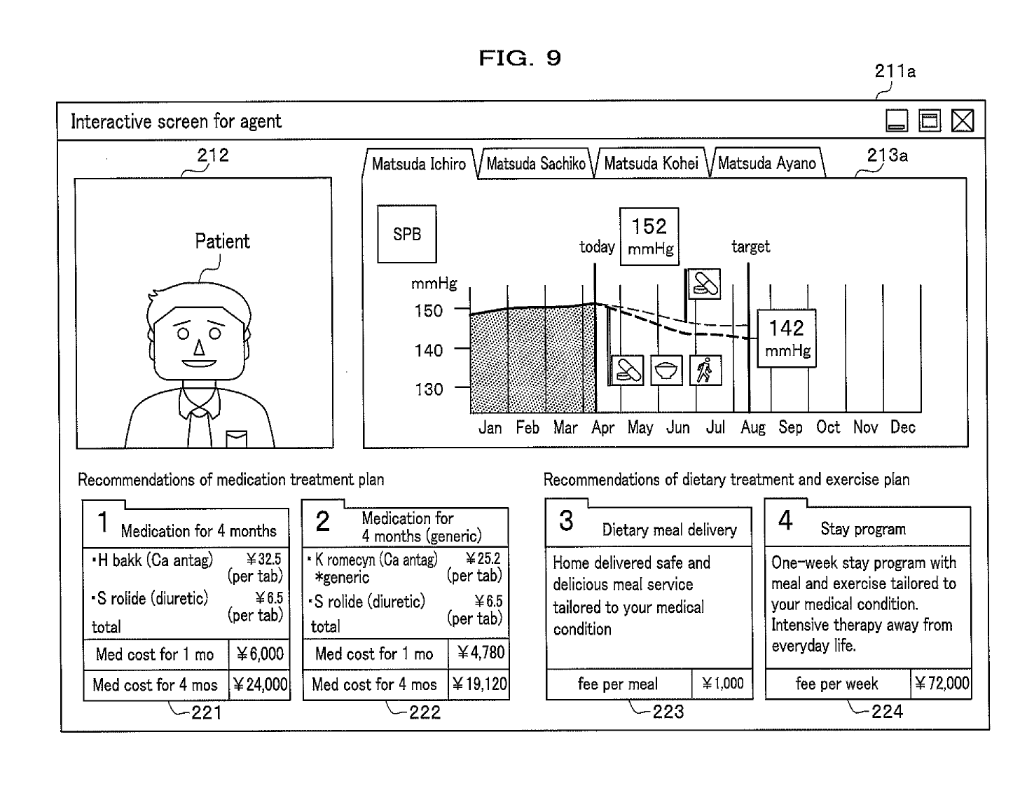

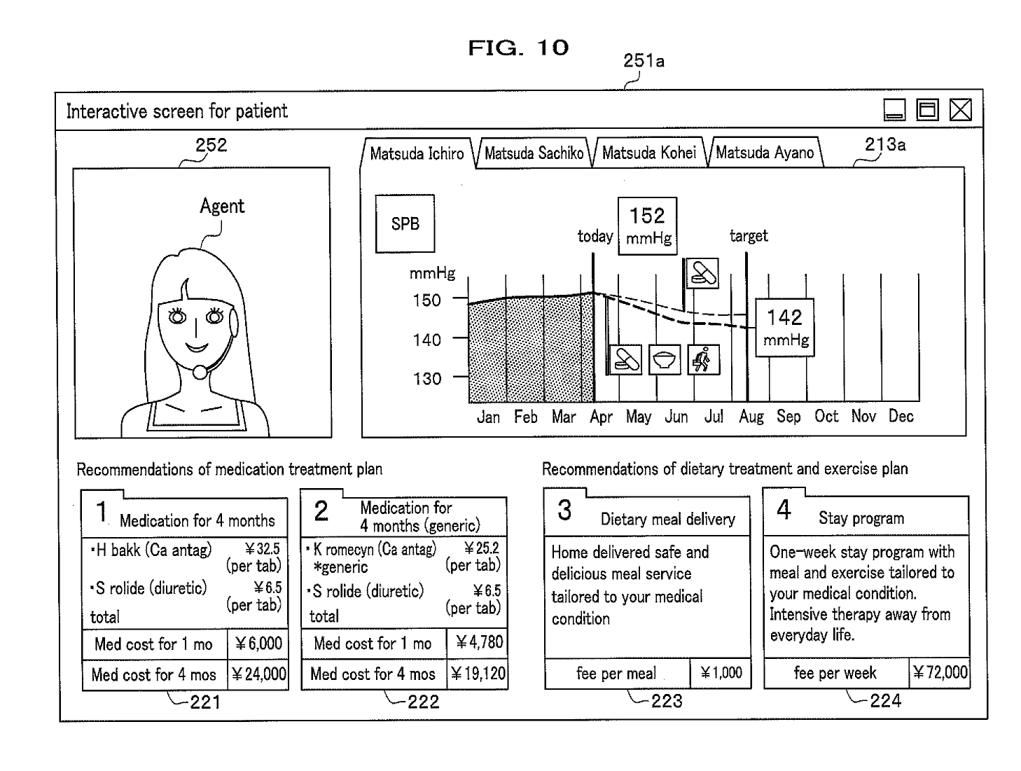

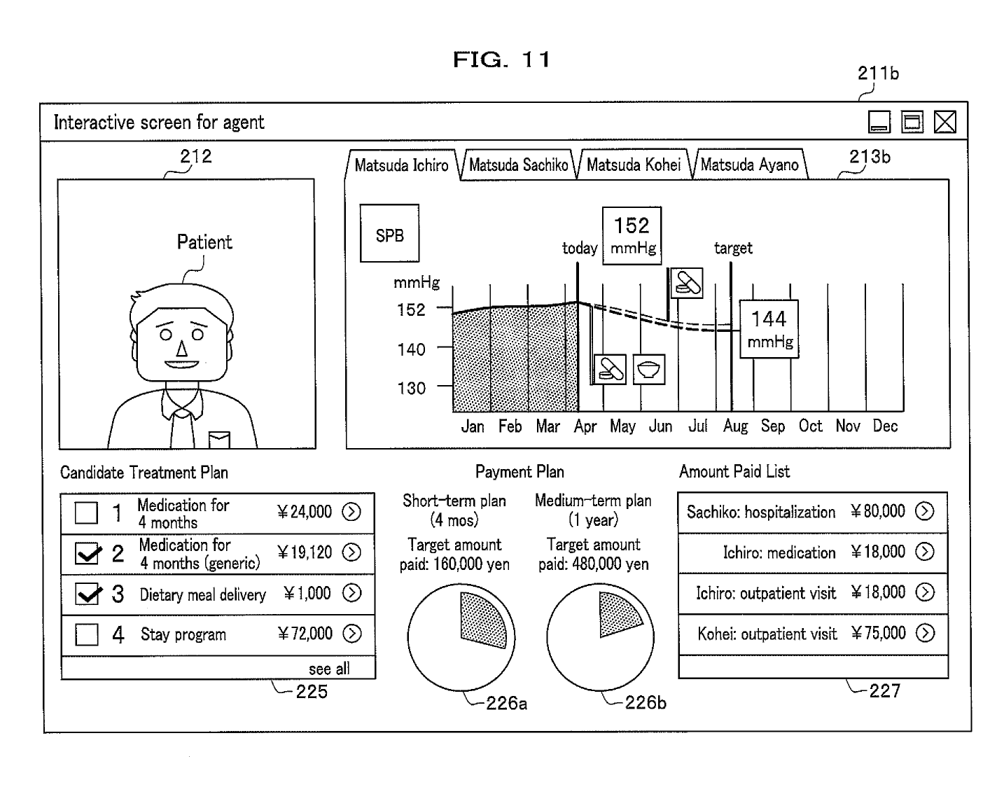

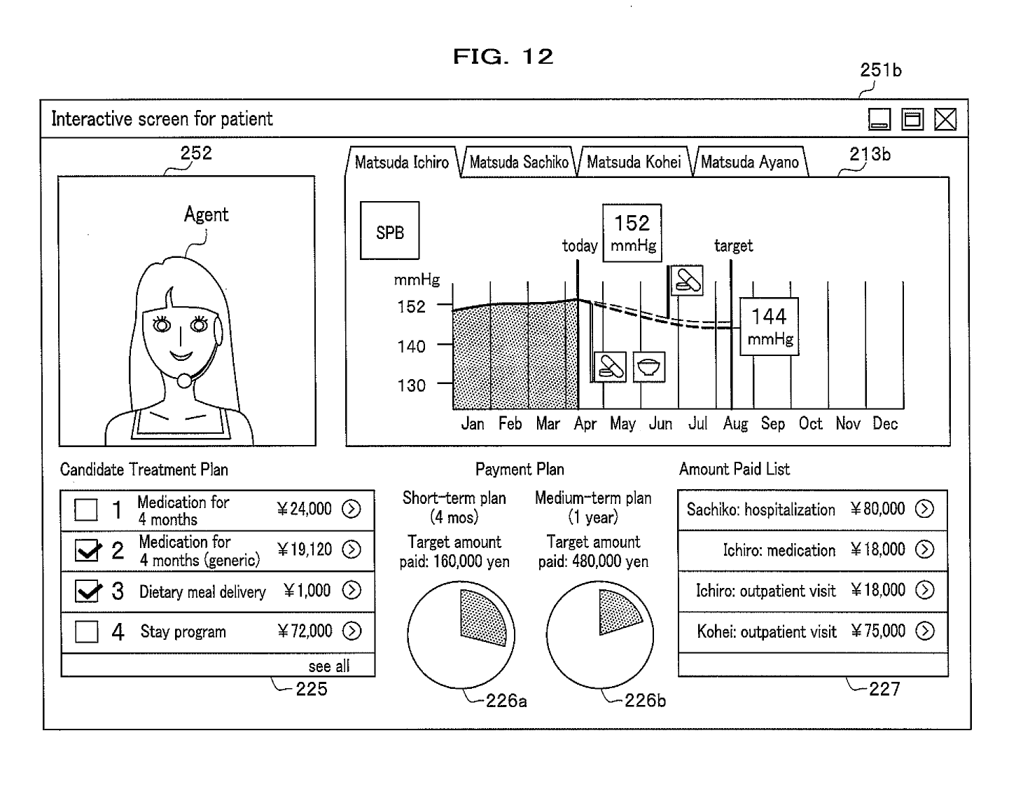

Next are described interactive screens for agent 211a, 211b and interactive screens for patient 251a, 251b with reference to FIGS. 9, 11, 10, and 12, respectively. When an agent looks at the interactive screen for agent 211a (FIG. 9), a patient looks at the interactive screen for patient 251a(FIG. 10). Similarly, when the agent looks at the interactive screen for agent 211b (FIG. 11), the patient looks at the interactive screen for patient 251b (FIG. 12). Note that the interactive screen for agent 211a and the interactive screen for agent 211b belong to a same screen. For easier understanding, the two screens are illustrated separately and are designated as the reference numeral 211a and the reference numeral 211b as screens before and after a treatment plan (to be described in detail hereinafter) is determined, respectively. The same applies to the interactive screen for patient 251a and the interactive screen for patient 251b.

The interactive screen for agent 211a of FIG. 9 includes a patient image area 212, a health value area 213a, medication recommendations 221, 222, and service recommendations 223, 224.

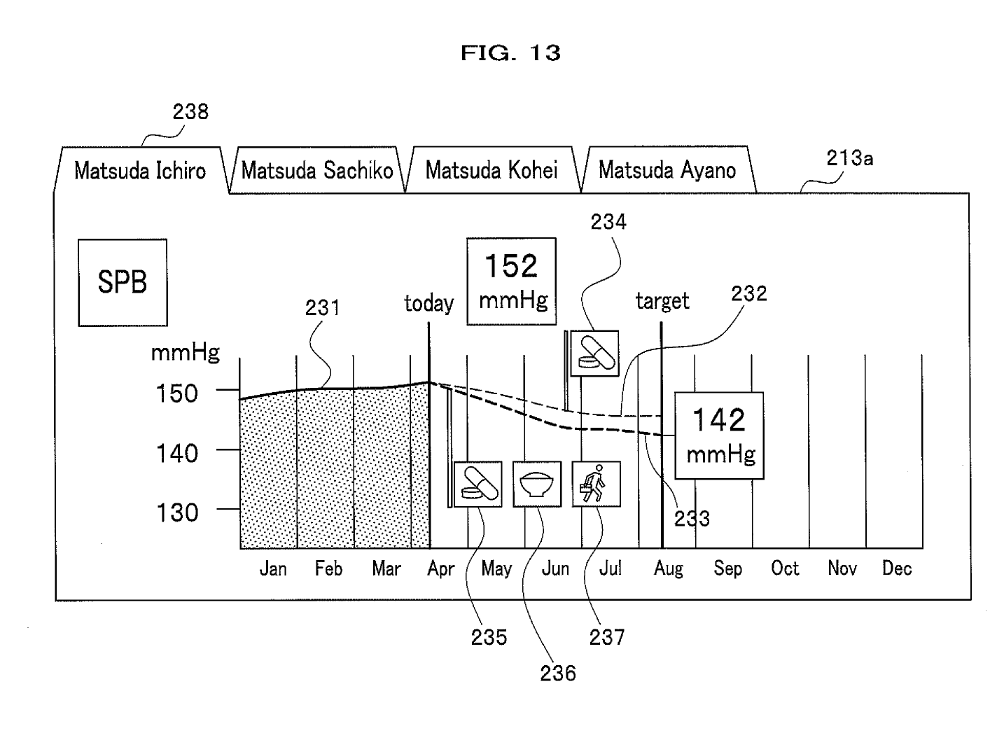

FIG. 13 is an enlarged diagram of the health value area 213a (FIG. 9). An axis of abscissas of a time series graph (containing lines 231 to 233) shows months of one year including a present time (a present day). An axis of ordinate shows one of the health value categories of the patient and is the “systolic blood pressure” herein. A bold solid line 231 (defining to a shaded area) in the time series graph represents past actual values. A thin broken line 232 and a bold broken line 233 in the time series graph represent estimated values of the health value for four months starting from the present day. The thin broken line 232 represents the estimated values in a case where the patient only takes an appropriate medication. The bold broken line 233 represents the estimated values in a case where the patient takes the medication and also uses (two) services. The time series graph provided herein is a line graph but may be instead a bar graph. Note that the health value area 213a has family member switching tags 238. The time series graph may also be referred to as a “time series graphic”.

Icons 234, 235 each represent a medication. Icons 236, 237 each represent a service. Even when the patient takes a plurality of different types of medications, only one icon of a “tablet” or an “ampule” of the plurality of medications is displayed as an example. In contrast, all of icons of candidate services are displayed because the agent needs to explain in detail the services to the patient.

The patient who looks at the health value area 213a readily understands the following:

(1) The systolic blood pressure is “152 mmHg” today.

(2) Application of the medication for the next four months alone will bring the systolic blood pressure down to about 145 mm Hg.

(3) Application of the medication for the next four months together with the two services will bring the systolic blood pressure down to about 142 mmHg.

The patient who further looks at the medication recommendations 221, 222, and the service recommendations 223, 224, in FIG. 10 readily understands the following:

(4) The patient needs to take a “calcium antagonist” and a “diuretic”.

(5) Candidates for the “Ca antagonist” are “H bakk” and “K romecyn”, the latter of which is lower in price.

(6) A candidate for the “diuretic” is “S rolide”.

(7) If the “H bakk” and the “S rolide” are taken for the next four months, a medication cost will be “24,000 yen”; and, if the “K romecyn” and the “S rolide”, “19,120 yen”.

(8) One of the two services is “dietary meal delivery”, details of which is “Home delivered safe and delicious meal service . . . ”, and of which fee per meal is “1,000 yen”.

(9) The other service is a “stay program”, details of which is “One-week stay program with meal and exercise . . . ”, and of which fee per week is “72,000 yen”.

(10) (Though depending on a subjective reaction of the patient,) if the patient can take some days off, the patient can use both of the services, “dietary meal delivery” and “stay program” during the vacations

Note that (2) to (7) described above are related to what the patient knows about the medication. To facilitate a deeper understanding of the medication, the interactive health management apparatus 5 can screen-display information other than that displayed in FIG. 10 and FIG. 13. For example, the interactive health management apparatus 5 can acquire information on a prescription or the like from a supporter and screen-display the acquired information.

The interactive screen for patient 251a of FIG. 10 includes an agent image area 252, the health value area 213a, the medication recommendations 221, 222, and the service recommendations 223, 224. The health value area 213a, the medication recommendations 221, 222, and the service recommendations 223, 224, are same as those illustrated in FIG. 9.

The interactive screen for agent 211b of FIG. 11 includes the patient image area 212, a health value area 213b, a recommendations selection area 225, payment plans 226a, 226b, and an amount paid list 227. The patient image area 212 is same as that illustrated in FIG. 9. The health value area 213b is similar to the health value area 213a (FIG. 9). The bold broken line in the time series graph of the health value area 213a described above has three icons and a health value of “142 mmHg” at a target time. On the other hand, a bold broken line in a time series graph of the health value area 213b (FIG. 11) has two icons and a health value of “144 mmHg” at the target time. Differences therebetween come from non-selection of “stay program” by the patient, of the two recommended services, namely, “dietary meal delivery” and “stay program”.

Rows of the recommendations selection area 225 correspond to, from top to bottom, the medication recommendations 221, 222, and the service recommendations 223, 224, in FIG. 9. The patient or the agent can select a desired medication and/or service from candidates thereof, by checking an appropriate checkbox. A combination of the selected medication and/or service is referred to as a “treatment plan” hereinafter.

The payment plan 226a shows a ratio of a scheduled payment amount for the next four months in line with the treatment plan for all family members, to a target total amount paid (100%). Similarly, the payment plan 226b shows a ratio of a scheduled payment amount for the entire year in line with the treatment plan for all the family members, to a target total amount paid (100%). The payment plan may also be referred to as “a graphic representing a ratio”.

The amount paid list 227 shows an amount actually paid for all the family members in and after January of the year.

The interactive screen for patient 251b of FIG. 12 includes the agent image area 252, a health value area 213b, a recommendations selection area 225, payment plans 226a, 226b, and the amount paid list 227. The agent image area 252 is same as that in FIG. 10. The health value area 213b, the recommendations selection area 225, the payment plans 226a, 226b, and the amount paid list 227 are same as those in FIG. 11.

The patient who looks at the health value area 213b, the recommendations selection area 225, the payment plans 226a, 226b, and the amount paid list 227 illustrated in FIG. 12 readily understands the following:
Decrease in the systolic blood pressure to “144 mmHg” is expected four months later as a result of the selection of the “application of (generic) medication for four months” and the “dietary meal delivery”.
The amount paid for the next four months is expected to be about 30% to the target amount as a result of the selection of the “application of (generic) medication for four months” and the “dietary meal delivery”.
Similarly, the amount paid for the entire year is expected to be 20% to the target amount.
(Though depending on a subjective reaction of the patient), the actual amount paid for the family members has reached a significant sum of money. Saving in household finance is necessary.

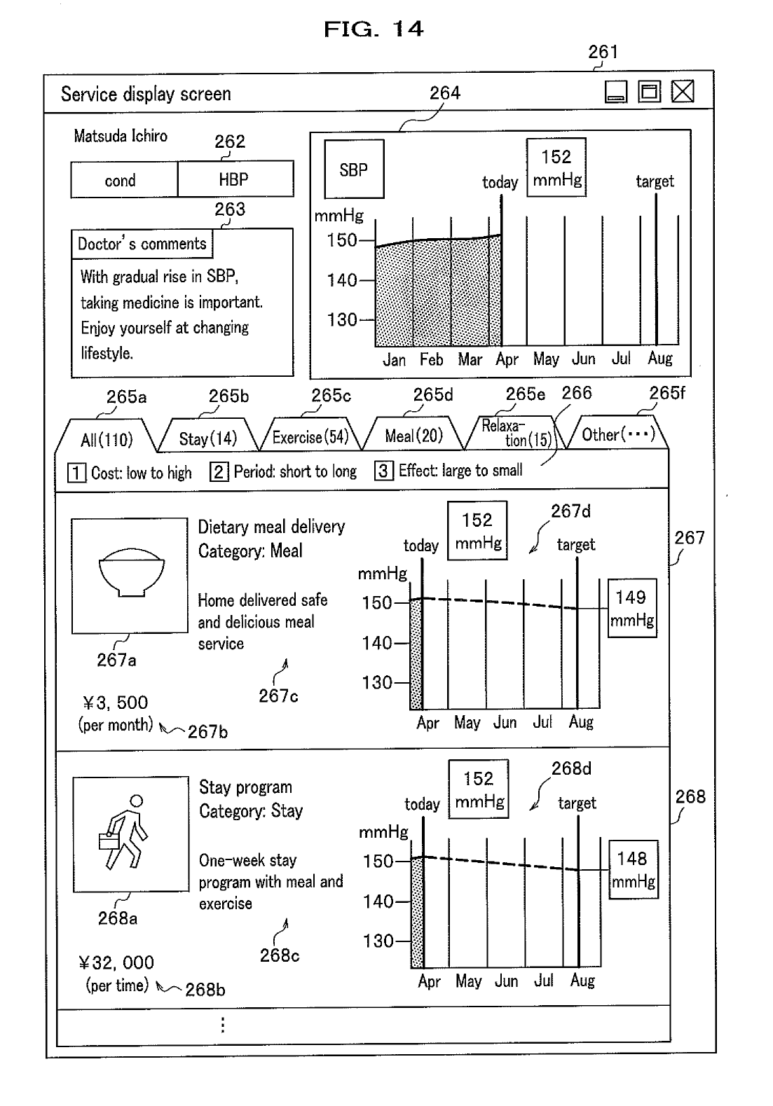

Next is described a service display screen 261 with reference to FIG. 14. The service display screen 261 is a screen by which the patient checks contents and the like of services prior to selection thereof. The service display screen 261 includes a current health condition field 262, a doctor's comments field 263, a health value 264, service category selection tags 265a to 265f, a display order selection field 266, and service candidate display fields 267, 268.

The current health condition field 262 displays a symptom or the like of the patient. The doctor's comments field 263 displays comments of a supporter such as a doctor. The health value 264 is same as the health value area 213a of FIG. 9 or the like but herein displays only values already having been acquired.

As described above, services are divided into a plurality of service categories. The service category selection tags 265a to 265f correspond to respective service categories. For example, when the patient selects the service category selection tag “exercise” 265c, appropriate services each having service category is “exercise” are displayed in the service candidate display fields 267, 268, or the like. When the patient selects the service category selection tag “all” 265a, all services are displayed in the service candidate display fields 267, 268, or the like. Note that a number in parentheses on each of the tags shows the number of services belonging to and stored in a service category of interest.

The display order selection field 266 displays three orders, namely, “cost: low to high”, “period: short to long”, and “effect: large to small”. Numbers “1”, “2”, and “3” given to the respective orders indicate priority orders having been entered into the “cost”, “period”, and “effect” columns in the selection priority entry field 205 (FIG. 8), respectively. The services are displayed in the service candidate display fields 267, 268, or the like: firstly, in ascending order of the cost; secondly, in ascending order of the effective use period for reference, if a plurality of services tie with an equal cost; and, lastly, in descending order of the degree of improvement, if a plurality of services tie with an equal effective use period for reference. The “1”, “2”, and “3” are displayed as default values as an example and the patient can re-enter and change the priority orders.

The service candidate display fields 267, 268, include icons 267a, 268a, fees 267b, 268b, service names 267c, 268c, and health value fields 267d, 268d, respectively.

Each of the health value fields 267d, 268d is same as the health value area 213a illustrated in FIG. 9 and the like but herein displays estimated values in a case where a service of interest alone is used.

A time series graph in the health value field 267d shows that, if the patient uses “dietary meal delivery”, the patient is expected to have a decrease in the systolic blood pressure to “149 mmHg” at a target time four months later. Similarly, a time series graph in the health value field 268d shows that, if the patient uses “stay program”, the patient is expected to have a decrease in the systolic blood pressure to “148 mmHg” at the target time four months later. In this manner, when the patient looks at the service display screen 261, the patient readily understands which service provides an effect to which degree.

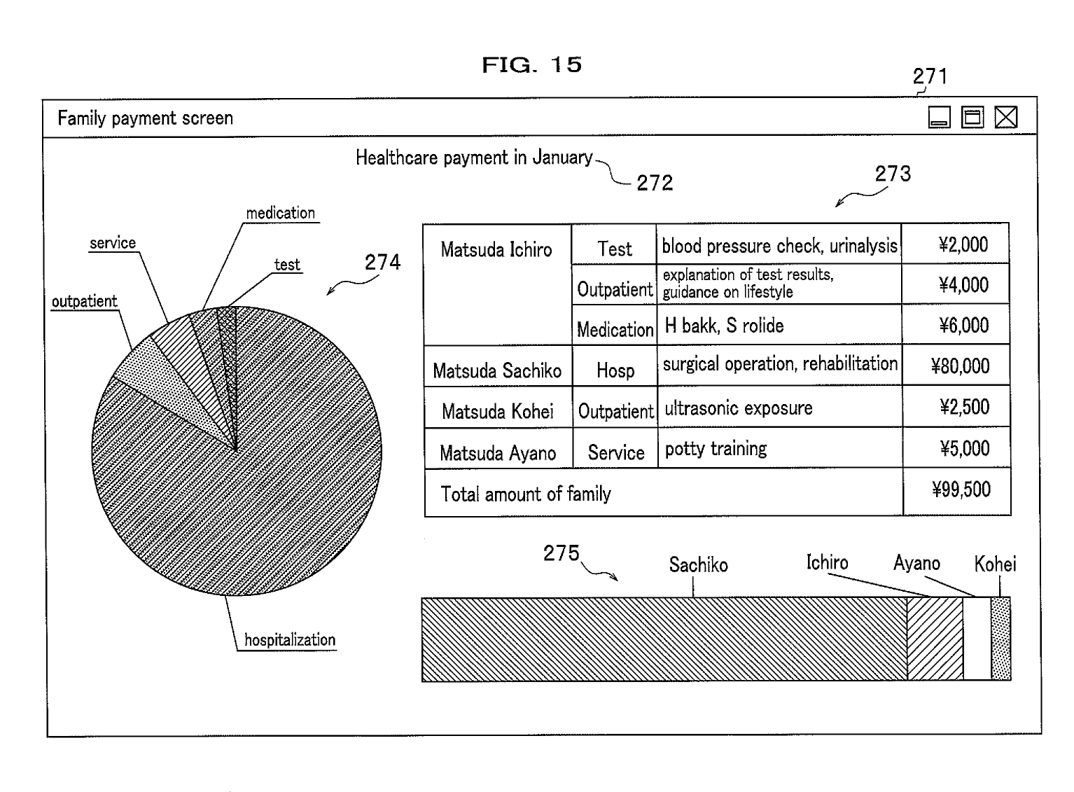

Next is described a family payment screen 271 with reference to FIG. 15. The family payment screen 271 includes a title 272, a family member-wise category-wise actual paid amount column 273, a category-wise pie chart 274, and a family member-wise band chart 275.

The title 272 shows which month of the year the family payment screen 271 displays. The month displayed may be plural consecutive months such as from January to March.

The family member-wise category-wise actual paid amount column 273 shows which family member paid which amount for which category in which month.

The category-wise pie chart 274 collects information contained in the family member-wise category-wise actual paid amount column 273 by category and shows a ratio for each of the categories to a sum total (100%) in pie chart form.

The family member-wise band chart 275 collects information contained in the family member-wise category-wise actual paid amount column 273 by the family member and shows a proportion for each of the family members to a sum total (100%) in band chart form.

Note that the category-wise pie chart 274 may be created in band chart form, and the family member-wise band chart 275 may be created in pie chart form.

### <Processing Procedures>

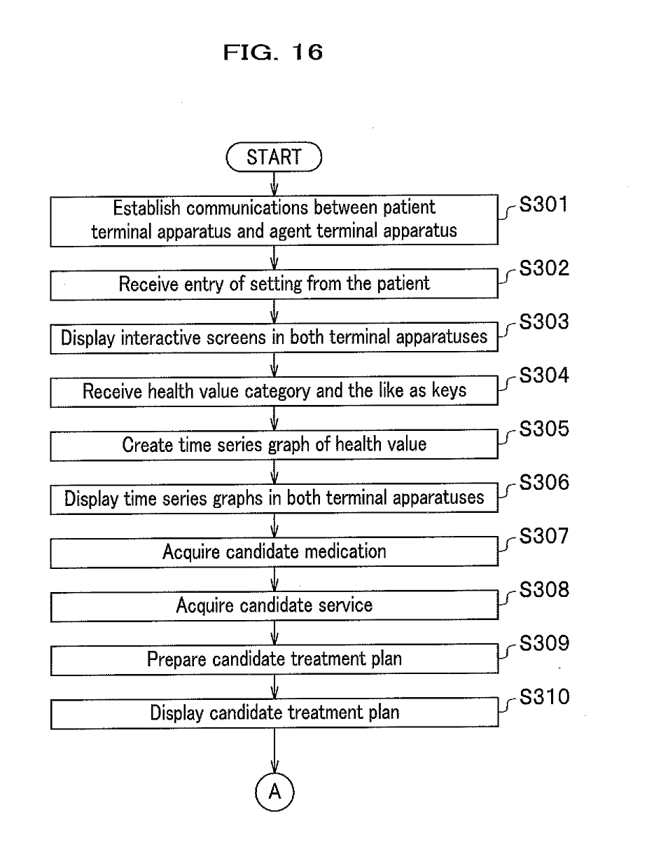

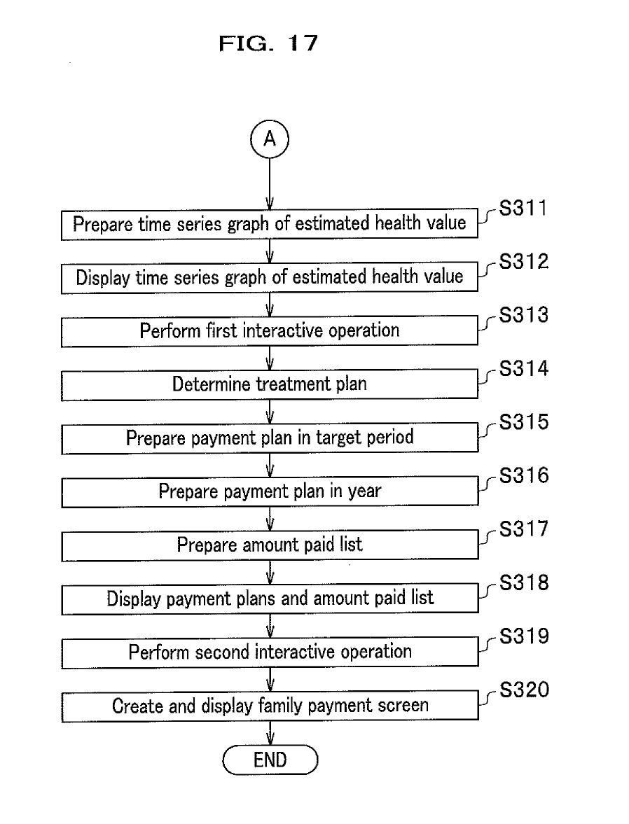

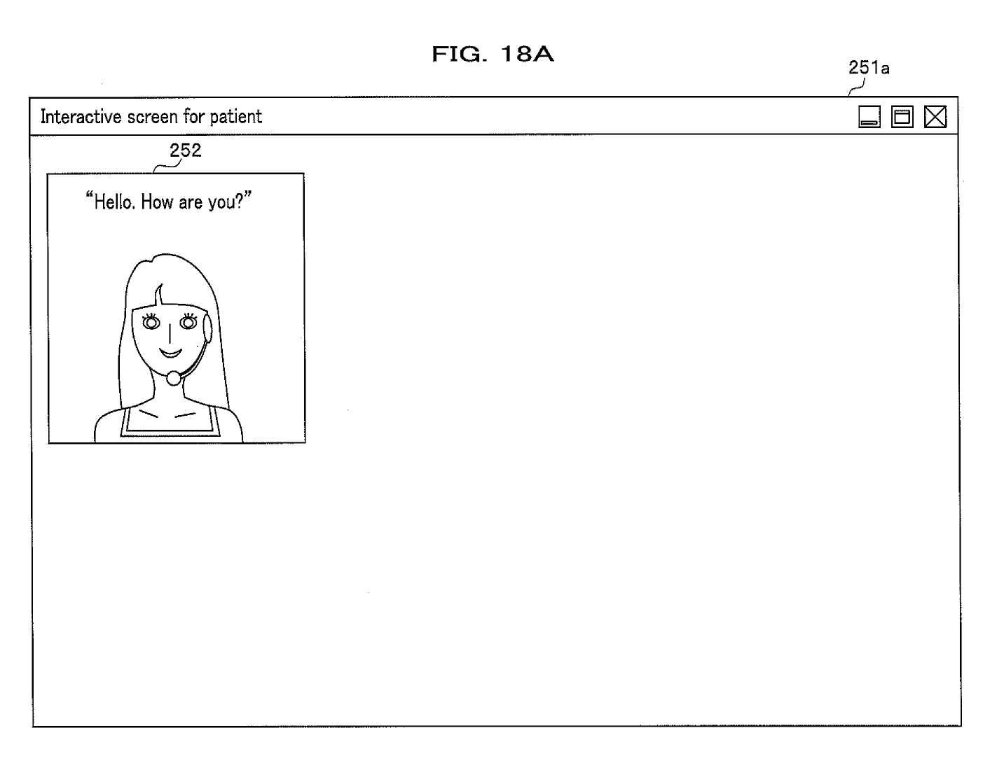

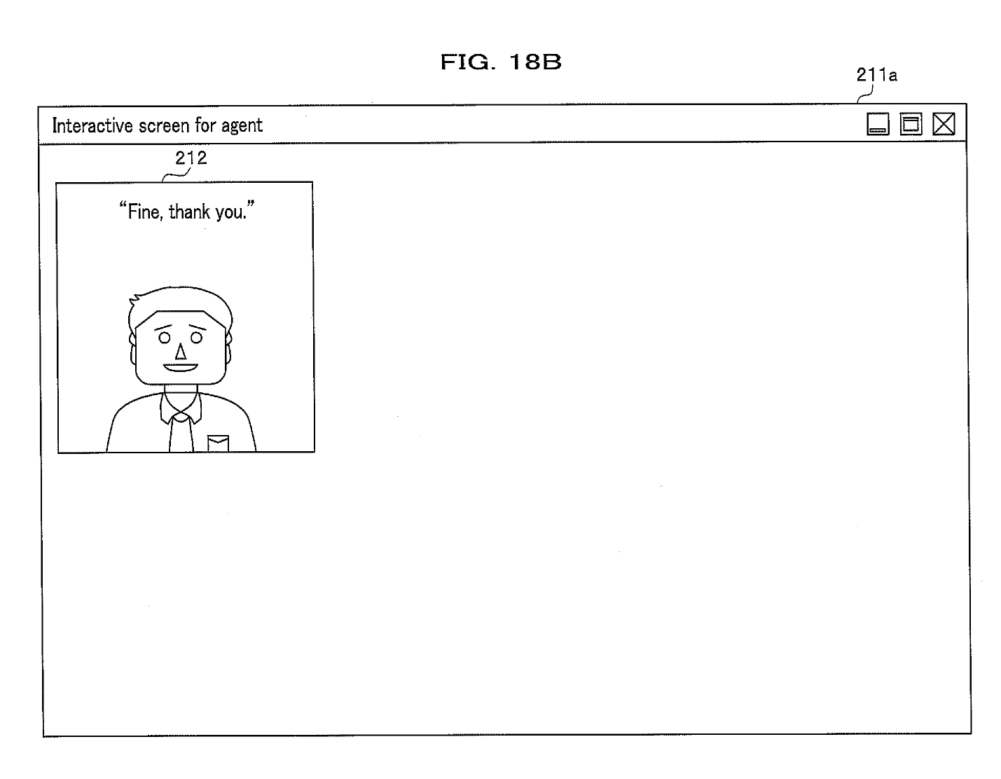

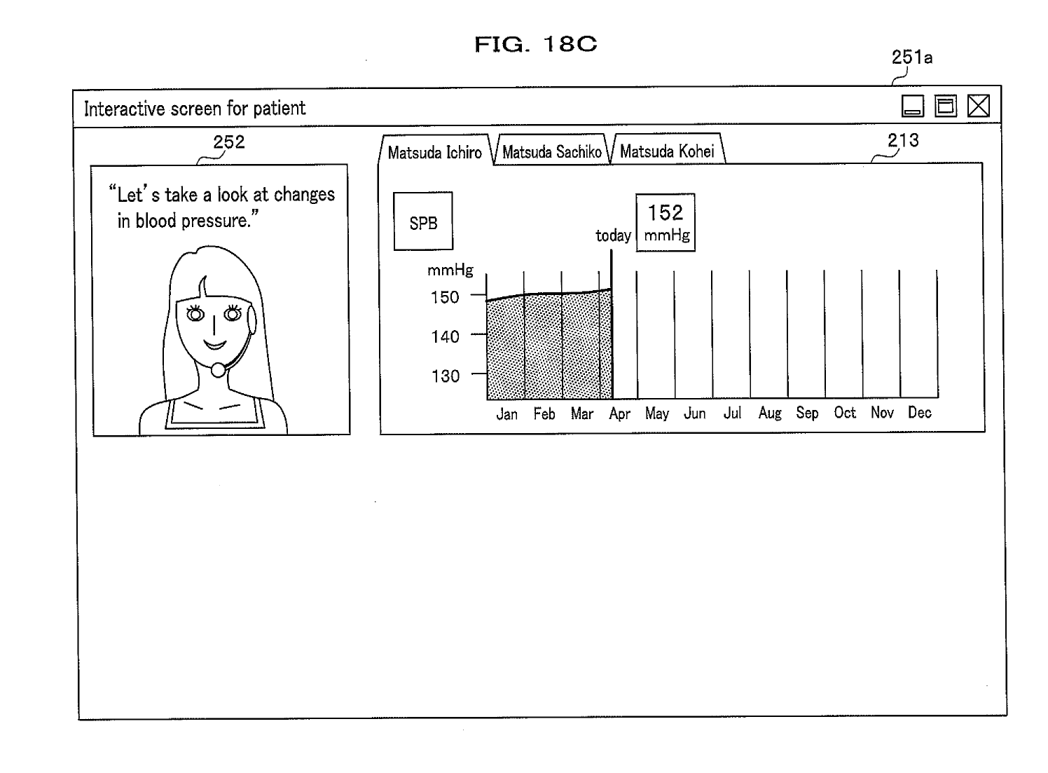

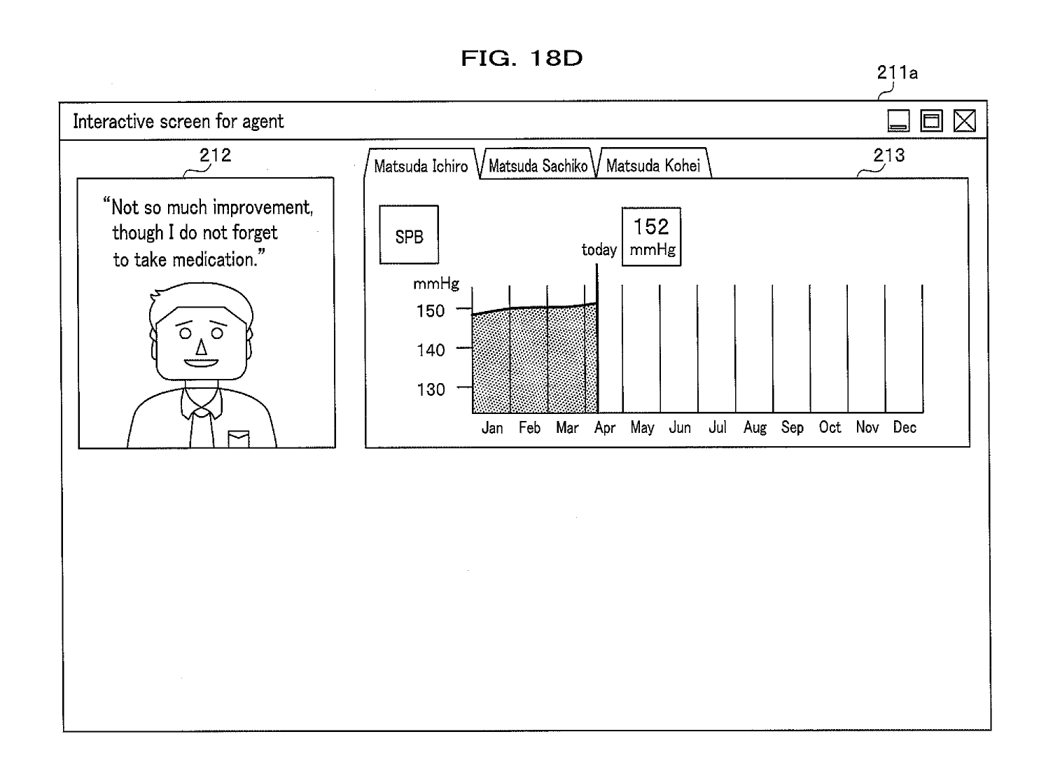

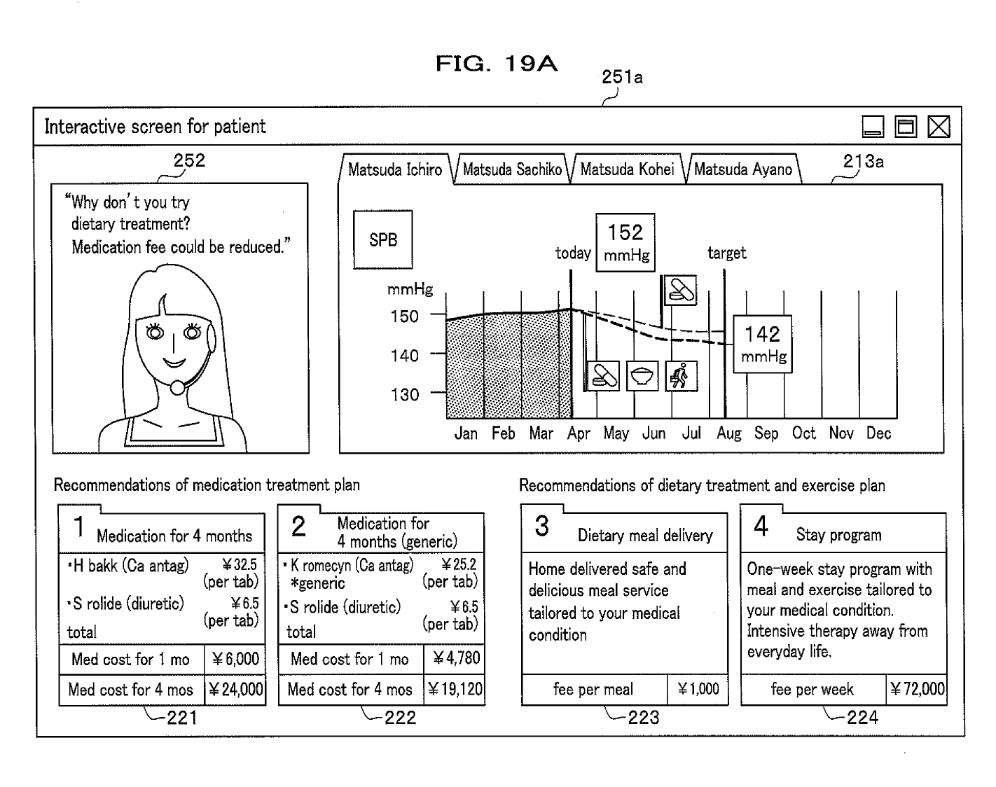

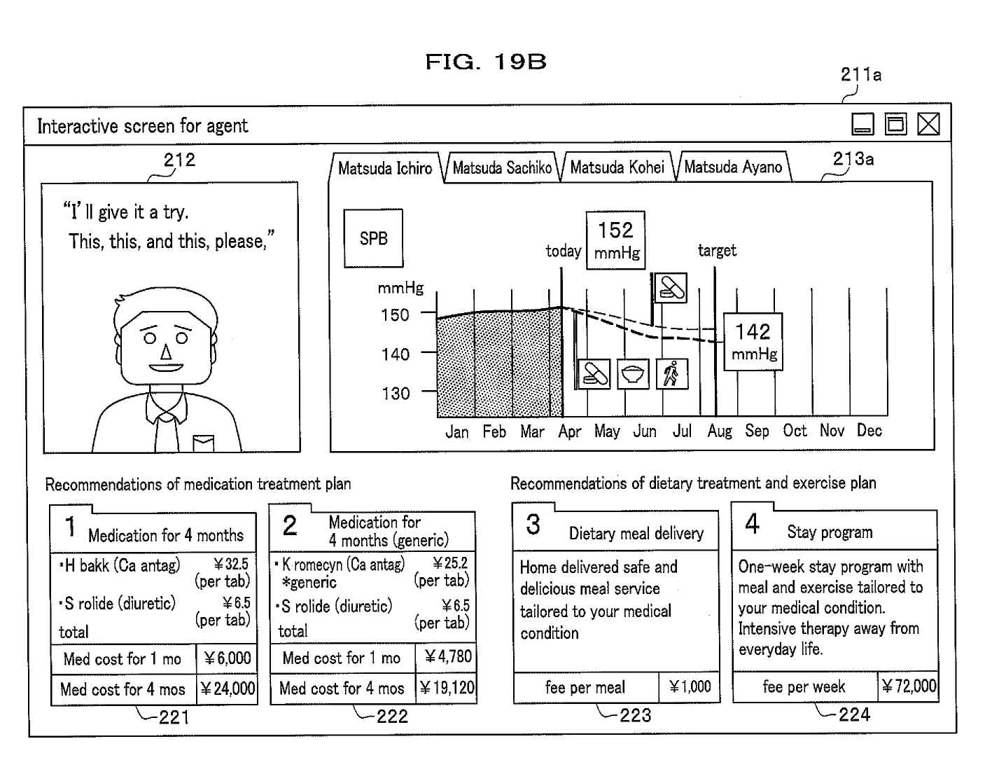

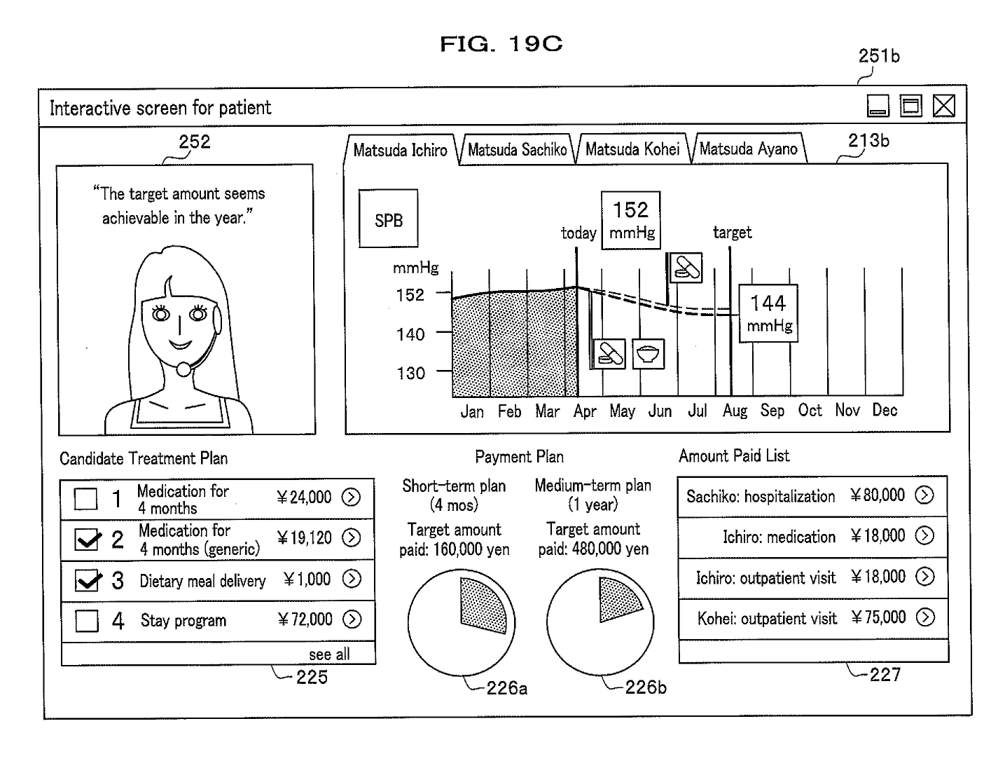

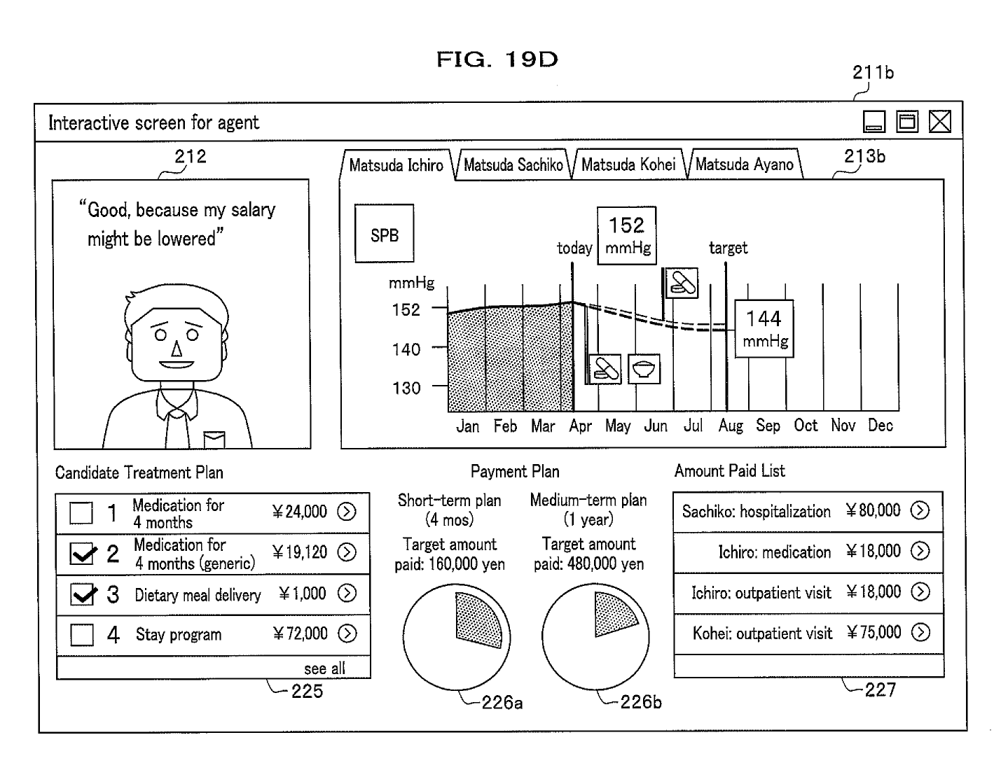

Next are described processing procedures with reference to FIG. 16 and FIG. 17 as well as FIG. 18 and FIG. 19 where appropriate. The following is assumed when the processing procedures get started. The health information 52, the medication information 53, the service information 54, and the family payment information 55 with data thereof ready in completed and available state is stored in the auxiliary storage device 35. The family information 51 is also stored in the auxiliary storage device 35 with appropriate data stored in the family ID column 101 to the birth date column 105 and with no data in the personal medical expense payment plan column 106 to the selection priority column 108.

In step S301, the transmitted and received information management unit 41 of the interactive health management apparatus 5 establishes communications between the patient terminal apparatus 2 and the agent terminal apparatus 3. A case is herein assumed in which the patient is “Matsuda Ichiro” and is operating the patient terminal apparatus 2.

In step S302, the terminal apparatus screen management unit 42 of the interactive health management apparatus 5 receives a setting from the patient. More specifically, firstly, the terminal apparatus screen management unit 42: creates the setting screen 201 (FIG. 8); transmits the screen 201 to the patient terminal apparatus 2; and displays the screen 201 in the output device 13.

Secondly, the terminal apparatus screen management unit 42 receives an entry of his/her personal ID via the input device 12 from the patient. The personal ID received may also be referred to as an “interactive personal ID”.

Thirdly, the terminal apparatus screen management unit 42 receives, from the patient, entries of: a checkmark on the service category, a checkmark on the medical service department, the personal medical expense payment schedule, and the selection priority (the priority orders of “cost” and the like), into the columns 202 to 205 of the setting screen 201, respectively; and a press down of the “Enter” button 206.

Fourthly, the terminal apparatus screen management unit 42: searches the family information 51 (FIG. 3) using the interactive personal ID as a key; and acquires a family ID of the resultant hit record. The terminal apparatus screen management unit 42 stores appropriate personal medical expense payment schedules received in the “third” substep of step S302, in the respective personal medical expense payment plan columns 106 of all records each having the acquired family ID. The terminal apparatus screen management unit 42 further stores a total amount in the received personal medical expense payment schedules, and the selection priority, in the family medical expense payment schedule column 107 and the selection priority column 108 of a record having the acquired family ID and “*” in the relationship column 104.

In step S303, the terminal apparatus screen management unit 42 displays respective interactive screens in respective terminal apparatuses of the patient and the agent. More specifically, the terminal apparatus screen management unit 42: creates the interactive screen for patient 251a and the interactive screen for agent 211a (at this time, columns on the screens are blank); transmits the screens 251a, 255a, to the patient terminal apparatus 2 and the agent terminal apparatus 3, respectively, via the network 4; and displays the screens 251a, 255a, in the respective output devices 13, 13.

The patient terminal apparatus 2: captures an image of the patient via the camera 17; captures a voice of the patient via the microphone 18; transmits the captured image and voice to the interactive health management apparatus 5 via the network 4. The terminal apparatus screen management unit 42: transmits the received image and voice to the agent terminal apparatus 3; and displays and reproduces the image and voice in the output device 13 and the speaker 19 of the agent terminal apparatus 3, respectively. A processing in a direction opposite to the above, that is, from the agent terminal apparatus 3 to the patient terminal apparatus 2 is similarly performed.

When step S303 is completed, the patient is assumed to look at the screen 251a illustrated in FIG. 18A; and the agent, the screen 211a illustrated in FIG. 18B.

In step S304, the terminal apparatus screen management unit 42 receives a health value category and the like which are served as keys. More specifically, the terminal apparatus screen management unit 42 receives a health value category and a target period as keys from the patient terminal apparatus 2 or the agent terminal apparatus 3.

The health value category as the key may be, for example, a voice of “systolic blood pressure” produced by the patient (or the agent), or a character string of “systolic blood pressure” entered by the patient (or the agent) via the input device 12. The terminal apparatus screen management unit 42 is assumed to be capable of converting a voice captured by the microphone 18 into character data.

The target period used herein is a period from a present day to a target date when the patient will evaluate the cost. For example, if it is mid-April now and the patient saves some money for a family trip during Japanese Bon vacation (in mid-August), the target period of “four months” is appropriate. The target period as the key may be, for example, a voice of “four months” produced by the patient (or the agent), or a character string of “four months” entered by the patient (or the agent) via the input device 12.

The health value category and the target period received in step S304 may also be referred to as a “key health value category” and an “evaluation target period”, respectively.

In step S305, the terminal apparatus screen management unit 42 creates a time series graph of health values. More specifically, firstly, the terminal apparatus screen management unit 42 acquires a record in the health information 52 (FIG. 4) which meets all of Conditions 1 to 3 as follows.

Condition 1: A personal ID of the record matches the interactive personal ID.

Condition 2: A health value category of the record matches the key health value category.

Condition 3: An acquisition date and time of the record corresponds to a period from a beginning of the year to the present date.

Secondly, the terminal apparatus screen management unit 42 creates a time series graph based on an acquisition date and time and a health value of the record acquired in the “first” substep of step S305.

In step S306, the terminal apparatus screen management unit 42 displays the time series graph in the terminal apparatuses of both the patient and the agent. More specifically, the terminal apparatus screen management unit 42: transmits the time series graph created in the “second” substep of step S305 to the patient terminal apparatus 2 and the agent terminal apparatus 3; and displays the time series graph in the respective output devices 13. When step S306 is completed, the patient is assumed to look at the screen 251a illustrated in FIG. 18C; and the agent, the screen 211a illustrated in FIG. 18D.

In step S307, the terminal apparatus screen management unit 42 acquires a candidate medication. More specifically, the terminal apparatus screen management unit 42 acquires a record which meets Condition 4 or Condition 5 as follows, from among the medication information 53 (FIG. 5) which is provided by the supporter.

Condition 4: A medication ID of the record matches the medication ID in the medical/service contents of the family payment information 55 (FIG. 7). The terminal apparatus screen management unit 42: searches the family payment information 55 using the interactive personal ID as a search key; and acquires the medical/service contents of the hit record.

Condition 5: a medicinal effect and a symptom of the record matches those of the record acquired in “Condition 4” and has an off-patent flag.

Assume a case in which the terminal apparatus screen management unit 42 acquires three records in rows 1 to 3 of the medication information 53 (that is, records on H bakk, S rolide, and K romecyn). “H bakk” and “S rolide” are medications which meet “Condition 4” (actually having been prescribed). “K romecyn” is a generic medication which meets “Condition 5”. Then, both the having-been-prescribed medications and the generic medication are displayed, details of which is described later.

In step S308, the terminal apparatus screen management unit 42 acquires a service candidate. More specifically, firstly, the terminal apparatus screen management unit 42 acquires, from the service information 54 (FIG. 6), a record which meets all of Condition 6 to Condition 8 as follows and, at the same time, at least one of Condition 9 and Condition 10 as follows.

Condition 6: A service category of the record of interest matches the service category received in the “third” substep of step S302.

Condition 7: A medical service department of the record matches the medical service department received in the “third” substep of step S302.

Condition 8: An effective use period for reference of the record does not exceed the evaluation target period.

Condition 9: A health value category stored in the numerical information on service effect for reference column 137 of the record matches the key health value category.

Condition 10: A symptom of the record is relevant to the key health value category. It is assumed herein that the auxiliary storage device 35 stores therein an association table in which a relationship between a key health value category and a symptom is defined. The association table stores therein, for example, the “systolic blood pressure” and the “high blood pressure (HBP)” in association with each other. The terminal apparatus screen management unit 42 can thus acquire the symptom “high blood pressure” based on the key health value category “systolic blood pressure”.

Secondly, the terminal apparatus screen management unit 42 arranges the records acquired in the “first” substep of step S308, based on the selection priority stored in the “fourth” substep of step S302. For example, if the selection priority is “(cost, period, effect)=(1, 2, 3)”, the terminal apparatus screen management unit 42 arranges the records: firstly, in ascending order of the cost; secondly, in ascending order of the effective use period for reference, if a plurality of services tie with an equal cost; and, lastly, in descending order of the degree of improvement, if a plurality of services tie with an equal effective use period for reference.

Thirdly, the terminal apparatus screen management unit 42 acquires a predetermined number of the records starting from a record at a top, which have been arranged in the “second” substep of the step S308. The predetermined number may be any number as long as the number is not less than “2”. This is because, if the predetermined number is not less than “2”, the patient can compare plural services. Explanation hereinafter is made assuming that the predetermined number is “2”.

It is assumed herein a case in which the terminal apparatus screen management unit 42 acquires, from among the service information 54, two records in rows 1 and 2 (that is, the records on dietary meal delivery and stay program).

In step S309, the terminal apparatus screen management unit 42 prepares a candidate treatment plan. More specifically, firstly, the terminal apparatus screen management unit 42 prepares the medication recommendations 221, 222 (FIG. 9 or the like), using the records of the medication information 53 acquired in step S307. Herein, the terminal apparatus screen management unit 42 prepares the medication recommendation 221 constituted by a medication or a combination thereof which the supporter has actually prescribed (which meets “Condition 4” described above). In some cases, meanwhile, an alternative medication different from that having been actually prescribed by the supporter, that is, a medication having a similar medicinal effect but lower in cost is present. In that case, the terminal apparatus screen management unit 42 prepares the medication recommendation 222 (FIG. 9 and the like) which contains the alternative medication in place of the prescribed medication. If the alternative medication has an off-patent flag, the terminal apparatus screen management unit 42 displays that “the medication is a generic” in association with the medication name.

Each of the medication recommendations 221, 222 of FIG. 9 shows “cost for four months”. The terminal apparatus screen management unit 42 calculates the “cost four months” using “(K001,3,2,14)” stored in the family payment information 55, the evaluation target period, and the (unit) price in the medication information 53.

Secondly, the terminal apparatus screen management unit 42 prepares the service recommendations 223, 224, using the record in the service information 54 acquired in the “third” substep of step S308.

In step S310, the terminal apparatus screen management unit 42 displays a candidate treatment plan. More specifically, the terminal apparatus screen management unit 42: transmits the medication recommendations 221, 222 and the service recommendations 223, 224 prepared in the “first” and “second” substeps of step S309, respectively, to the patient terminal apparatus 2 and the agent terminal apparatus 3; and displays the recommendations 221, 222 and the service recommendations 223, 224 in the respective output devices 13, 13. The displayed medication recommendations 221 to 224 contain respective costs.

In step S311, the terminal apparatus screen management unit 42 prepares a time series graph of an estimated health value. More specifically, firstly, the terminal apparatus screen management unit 42 prepares the time series graph of an estimated health value in a case of relying only on medication application. For example, if one certain medication is applied, the terminal apparatus screen management unit 42 multiplies a current health value by “1+degree of improvement of medication/12”, to thereby estimate a health value one month later from a present date. The current health value is an actual value of the present date, or, if the actual value of the present date is not available, the most recent actual value. If a plurality of medications are applied, the current health value is multiplied by “1+Σ degrees of improvement/12”. The Σ degrees of improvement means a total sum of the degrees of improvement of a plurality of the medications. The same applies to the estimated health values two, three, . . . , months later.

Secondly, the terminal apparatus screen management unit 42 prepares a time series graph of an estimated health value in a case of using a service in addition to the medication application. For example, if one certain service is used, the terminal apparatus screen management unit 42 multiplies the current health value by “1+degrees of improvement of service/12”, to thereby estimate the health value one month later from the present date. For example, if a plurality of medications are applied, and a plurality of services are used as well, the current health value is multiplied by “1+(Σ degrees of improvement of medication/12+Σ degrees of improvement of service/12)”. The Σ degrees of improvement of medication is a total sum of degrees of improvement of a plurality of medications. The Σ degrees of improvement of service is a total sum of degrees of improvement of a plurality of medications. The same applies to the degrees of improvement two, three, . . . , months later.

In step S312, the terminal apparatus screen management unit 42 displays a time series graph of an estimated health value. More specifically, the terminal apparatus screen management unit 42: transmits the time series graphs of estimated health values (in the cases of only medication, and both medication and service) prepared in the “first” and “second” substeps of step S311, respectively, to the patient terminal apparatus 2 and the agent terminal apparatus 3; and displays the time series graphs in the output devices 13, 13. At this time, the terminal apparatus screen management unit 42 also displays the icons 234 to 237 (FIG. 13) on the time series graph of estimated health values.

When step S312 is completed, the patient is assumed to look at the screen 251a illustrated in FIG. 19A; and the agent, the screen 211a illustrated in FIG. 19B.

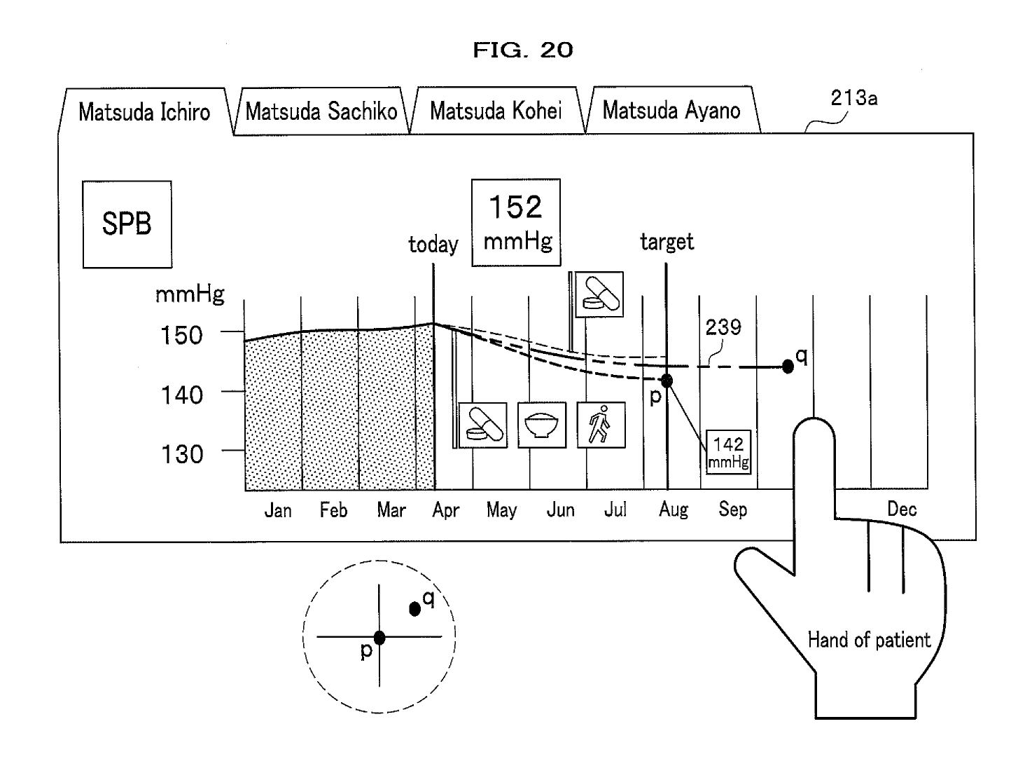

Before explaining step S313, a first interactive operation is described with reference to FIG. 20. The interactive operation is a two-way repetitive operation in which the following is repeatedly performed: a patient moves a graphic with his/her finger, a mouse, or the like; and, in response, the terminal apparatus screen management unit 42 receives the patient's operation as a new entry and carries out an appropriate processing. A second interactive operation will be described later.

In FIG. 20, assume a case in which the patient moves an end point p of a time series graph (in bold broken line) displayed in the health value area 213a of the interactive screen for patient 251a, up to a point q with his/her finger. This makes a “bold two-dot chain line” 239 extended to the point q by a length corresponding to a period of two months. The “bold two-dot chain line” 239 is drawn in light color. Regarding a positional relationship of the point p and the point q on a plane of coordinates, the point q is situated upper right of the point p (see a circle in dashed line). This means that the patient “specifies the point q having a longer evaluation target period and a smaller effect than those of the point p”. In other words, the patient takes a smaller degree of improvement and a longer effective use period for reference as acceptable.

Next is described how to perform step S313 assuming a case in which “the bold two-dot chain line is extended by a length corresponding to a period of two months, and the point p is shifted upper right to the point q”.

In step S313, the terminal apparatus screen management unit 42 performs the first interactive operation. More specifically, firstly, the terminal apparatus screen management unit 42 lowers priority orders of both the “period” and “effect” in the selection priority. The selection priority herein is “(cost, period, effect)=(1, 2, 3)”, and the terminal apparatus screen management unit 42 thus does nothing. In another case, for example, if the selection priority is “(cost, period, effect)=(3, 2, 1)”, the terminal apparatus screen management unit 42 changes the selection priority to “(cost, period, effect)=(1, 2, 3) or (1, 3, 2)”.

Secondly, the terminal apparatus screen management unit 42: adds the period corresponding to the length having been extended of the “bold two-dot chain line”, to the evaluation target period; and thereby determines a new evaluation target period. In this example, the new evaluation target period is six months (four months+two months).

Thirdly, the terminal apparatus screen management unit 42: arranges the records of the service information 54 (FIG. 6) in descending order of the degree of improvement; omits the first to n-th (n=2, 3, . . . ) records; rearranges the records in ascending order of the effective use period for reference; and omits the first to n-th records. Any number can be set as “n”.

Fourthly, the terminal apparatus screen management unit 42 repeatedly performs steps S305 to S311. More specifically, the terminal apparatus screen management unit 42: in performing the “third” substep of step S308 in the repeated processing, randomly reacquires a predetermined number of records in the service information 54; and performs S305 to S311 until a number of times of the repetition reaches a predetermined threshold. The “first” substep of step S311 is skipped in the repeated processing. When the number of times of the repetition reaches the predetermined threshold, it is assumed that preparation of the time series graphs of estimated health value as many as the predetermined threshold is completed by the terminal apparatus screen management unit 42.

Fifthly, the terminal apparatus screen management unit 42 determines, from among the prepared time series graphs of estimated health values, a time series graph having a curve line best approximate to the “bold two-dot chain line” 239 of the time series graph of FIG. 20. The terminal apparatus screen management unit 42 displays the determined time series graph of estimated health values with the “bold two-dot chain line” in dark color; and deletes the already-displayed “bold two-dot chain line” in light color.

Next is described how to perform step S313 assuming a case in which “the bold two-dot chain line is extended by a length corresponding to a period of two months, and the point p is shifted lower right to the point q”. In this case, this means that the patient “specifies the point q having a longer evaluation target period and a larger effect than those of the point p”. In other words, the patient desires a larger degree of improvement, even though the effective use period for reference becomes longer. Then the “first” through “third” substeps of step S313 explained above are differently performed, which are described below.

In step S313, the terminal apparatus screen management unit 42 performs the first interactive operation. More specifically, firstly, the terminal apparatus screen management unit 42 lowers the priority order of the “period” and raises the priority order of the “effect” with respect to the selection priority. The selection priority is originally “(cost, period, effect)=(1, 2, 3)”. The terminal apparatus screen management unit 42 thus changes the selection priority to “(cost, period, effect)=(1, 3, 2)”.

Secondly, the terminal apparatus screen management unit 42: adds the period corresponding to the length having been extended of the “bold two-dot chain line”, to the evaluation target period; and thereby determines a new evaluation target period. In this example, the new evaluation target period is six months (four months+two months).

Thirdly, the terminal apparatus screen management unit 42: arranges the records of the service information 54 (FIG. 6) in ascending order of the degree of improvement; omits the first to n-th (n=2, 3, . . . ) records; rearranges the records in ascending order of the effective use period for reference; and omits the first to n-th records. Any number can be set as “n”.

In sum, the terminal apparatus screen management unit 42: arranges the records in the service information 54 (FIG. 6) in orders of the degree of improvement and the effective use period for reference, based on in which position the point q is situated with respect to the point p (upper right, lower right, lower left, and upper left); and omits a highly or lowly prioritized candidate record where appropriate. There are four ways of how to omit a candidate record, namely: with respect to the degree of improvement, omission of a highly prioritized record (having a larger degree of improvement), omission of a lowly prioritized record (having a smaller degree of improvement); and, with respect to the effective use period for reference, omission of a highly prioritized record (having a shorter effective use period for reference); and omission of a lowly prioritized record (having a longer effective use period for reference). There are thus four combinations of omitting a record, which correspond to respective positions of the point q with respect to the point p (upper right, lower right, lower left, and upper left).

The patient can perform the first interactive operation as many times as he/she likes. For each time of the operation, the terminal apparatus screen management unit 42 displays the health value area 213a, the medication recommendations 221, 222, and the service recommendations 223, 224, with appropriate changes, on the interactive screen for agent 211a (FIG. 9) and the interactive screen for patient 251a (FIG. 10).

In step S314, the terminal apparatus screen management unit 42 determines a treatment plan. More specifically, firstly, the terminal apparatus screen management unit 42 creates the recommendations selection area 225. The terminal apparatus screen management unit 42 can create the recommendations selection area 225 based on the information used for preparing the medication recommendations 221, 222, and the service recommendation 223, 224.

Secondly, the terminal apparatus screen management unit 42: transmits the created recommendations selection area 225 to the patient terminal apparatus 2 and the agent terminal apparatus 3; and displays the recommendations selection area 225 in the respective output devices 13, 13. At this time, the terminal apparatus screen management unit 42: deletes (or hides) the currently-displayed medication recommendations 221, 222, and the service recommendations 223, 224 from the respective screens of the output devices 13, 13; and then displays the recommendations selection area 225 in a space which has become blank.

Thirdly, the terminal apparatus screen management unit 42 receives an entry of one or more checkmarks into checkboxes in the recommendations selection area 225 by the patient or the agent.

With the above-described processing, the terminal apparatus screen management unit 42 determines the treatment plan of “Matsuda Ichiro”. The terminal apparatus screen management unit 42 can also determine respective treatment plans of “Matsuda Sachiko”, “Matsuda Kohei”, and “Matsuda Ayano” based on an entry by “Matsuda Ichiro”, by repeatedly performing steps S304 to S314.

When the repeated processing is completed, the terminal apparatus screen management unit 42 stores information on each of the family members in the main storage device 34 as follows:
a record of the medication information 53 (FIG. 5) on a medication included in the determined treatment plan;
a record of the service information 54 (FIG. 6) on a service included in the determined treatment plan; and
a medication ID of a medication actually having been taken and a frequency thereof (for example, two tablets three times a day for 14 days).

The aforementioned information may also be referred to as “payment plan basic information”.

In step S315, the terminal apparatus screen management unit 42 prepares a payment plan in a target period. More specifically, firstly, the terminal apparatus screen management unit 42: collects all records of the payment plan basic information (family by family); and calculates an amount paid in the evaluation target period. If the record is of the medication, the amount paid thereof in the evaluation target period is calculated by multiplying a price by a frequency taken.

Secondly, the terminal apparatus screen management unit 42: searches the family information 51 (FIG. 3); and acquires a family ID of the hit record. The terminal apparatus screen management unit 42 then acquires a family medical expense payment schedule of a record which has the acquired family ID and also has “*” in the relationship column 104. The terminal apparatus screen management unit 42 adds up amounts during the evaluation target period in the acquired family medical expense payment schedule, to thereby calculate the target amount. If “four months” of the evaluation target period starting from a present day fall on “April, May, June, July”, as in the example of “Matsuda Ichiro” illustrated in FIG. 4, the target amount is calculated to be 4+4+4+4=16 ten thousand yen.

Thirdly, the terminal apparatus screen management unit 42 creates a pie chart in which: the target amount calculated in the “second” substep of step S315 is set as a total (100%); and the amount paid in the evaluation target period calculated in the “first” substep of step S315 is represented as a ratio to the total, which is referred to as the payment plan 226a.

In step S316, the terminal apparatus screen management unit 42 prepares a payment plan in a year including the target period. More specifically, firstly, the terminal apparatus screen management unit 42 performs steps S304 to S314 once again assuming the target period as “a period from the present day through December”, except omission of displaying the respective screens in the output devices 13, 13 of the patient terminal apparatus 2 and the agent terminal apparatus 3.

Secondly, the terminal apparatus screen management unit 42 collects (family by family) all of the records of the payment plan basic information acquired in the repeated processing in the “first” substep of step S316; and thereby calculates the amount paid in the evaluation target period.

Thirdly, the terminal apparatus screen management unit 42: searches the family information 51 (FIG. 3) using the interactive personal ID as a search key; and acquires a family ID of the hit record. The terminal apparatus screen management unit 42 then acquires a family medical expense payment schedule of a record which has the acquired family ID and also has “*” in the relationship column 104. The terminal apparatus screen management unit 42 acquires an amount arranged last (an annual budget) in the acquired family medical expense payment schedule, which is determined as an annual target amount.

Fourthly, the terminal apparatus screen management unit 42: searches the family information 51 (FIG. 3) using the interactive personal ID as a search key; and acquires a family ID of the hit record. The terminal apparatus screen management unit 42 then acquires all personal IDs associated with the acquired family ID.

Fifthly, the terminal apparatus screen management unit 42: searches the family payment information 55 (FIG. 7) using all of the personal IDs acquired in the “fourth” substep of step S316 as search keys; and acquires all of the hit records. The terminal apparatus screen management unit 42 adds up amounts paid of all the hit records. The resultant sum is referred to as a past actual paid amount.

Sixthly, the terminal apparatus screen management unit 42 creates a pie chart in which: the annual target amount is set as a total sum (100%); and a sum of the amount paid and the past actual paid amount in the evaluation target period is represented as a ratio to the total, which is referred to as the payment plan 226b.

In step S317, the terminal apparatus screen management unit 42 prepares the amount paid list 227. More specifically, the terminal apparatus screen management unit 42 creates a data such as “Matsuda Sachiko, hospitalization cost, 80,000 yen” based on each of the records acquired in the “fifth” substep of step S316. The terminal apparatus screen management unit 42 arranges plural pieces of the data in descending order of the amounts paid, to thereby create the amount paid list 227.

In step S318, the terminal apparatus screen management unit 42 displays the payment plans and the amount paid list. More specifically, the terminal apparatus screen management unit 42: transmits the payment plans 226a, 226b, and the amount paid list 227 created in steps S315 to S317 to the patient terminal apparatus 2 and the agent terminal apparatus 3; and displays the plans 226a, 226b, and the list 227 in the output devices 13, 13.

When step S318 is completed, the patient is assumed to look at the screen 251b illustrated in FIG. 19C; and the agent, the screen 211b illustrated in FIG. 19D.

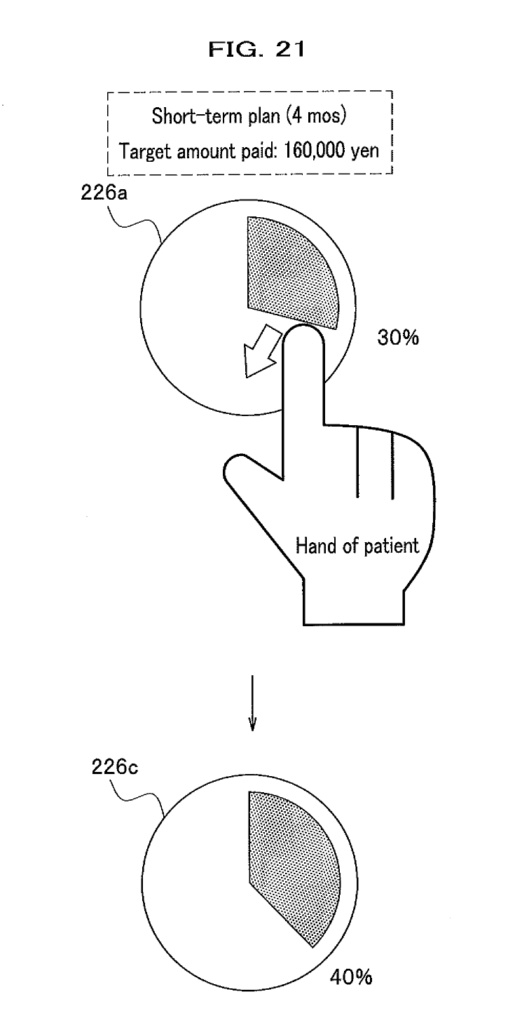

Before explaining step S319, the second interactive operation is described with reference to FIG. 21. It is assumed herein that: the patient shifts a radius indicating a percentage of “30%” of the pie chart of the payment plan 226a displayed on the interactive screen for patient 251b (FIG. 12) with his finger until the radius indicates a percentage of “40%”. A pie chart 226c indicating the 40% is represented in light color. The shift means that the patient considers that an increase in the amount paid for all the family members in the evaluation target period by 160,000 yen×(40%-30%)=16,000 yen is acceptable.

Next is described step S319 assuming a case in which “the percentage is shifted from the “30%” to the “40%””.

In step S319, the terminal apparatus screen management unit 42 performs the second interactive operation. More specifically, firstly, the terminal apparatus screen management unit 42 brings down the priority order of “cost” as the selection priority. The current selection priority is “(cost, period, effect)=(1, 2, 3)”. The terminal apparatus screen management unit 42 thus changes the selection priority to “(cost, period, effect)=(3, 1, 2)”.

Secondly, the terminal apparatus screen management unit 42: arranges the records in the service information 54 (FIG. 6) in ascending order of cost; and omits the first to n-th (n=2, 3, . . . ) records. Any number can be set as “n”.

Thirdly, the terminal apparatus screen management unit 42 repeatedly performs steps S305 to S311, S314, and S315. More specifically, the terminal apparatus screen management unit 42: in performing the “third” substep of step S308, randomly reacquires a predetermined number of records in the service information 54; and performs steps S305 to S311, S314, and S315 until a number of times of the repetition reaches a predetermined threshold, though the “first” substep of step S311 is herein skipped. When the number of times of the repetition reaches the predetermined threshold, it is assumed that the terminal apparatus screen management unit 42 has completed

preparation of the payment plans 226a (pie charts) of the evaluation target period as many as the predetermined threshold.

Fourthly, the terminal apparatus screen management unit 42 determines, from among the prepared payment plans 226a, a payment plan having a percentage most approximate to the “40%”. The terminal apparatus screen management unit 42 displays the determined payment plan 226a in dark color; and deletes the already-displayed payment plan 226a in light color.

Next is described how to perform step S319 assuming a case in which “the percentage is shifted from the “30%” to the “40%”. In this case, the shift means that the patient desires a decrease in the amount paid for all the family members in the evaluation target period by 160,000 yen×(40%-30%)=16,000 yen. The “first” and “second” substeps of step S319 explained above are thus differently performed as described below.

In step S319, the terminal apparatus screen management unit 42 performs the second interactive operation. More specifically, firstly, the terminal apparatus screen management unit 42 raises the priority order of “cost” as the selection priority. The current selection priority is “(cost, period, effect)=(1, 2, 3)”. The terminal apparatus screen management unit 42 thus does nothing. In another case, for example, if the selection priority is “(cost, period, effect)=(3, 2, 1)”, the terminal apparatus screen management unit 42 changes the selection priority to “(cost, period, effect)=(1, 3, 2)”.

Secondly, the terminal apparatus screen management unit 42: arranges the records of the service information 54 (FIG. 6) in descending order of cost; and omits the first to n-th (n=2, 3, . . . ) records. Any number can be set as “n”.

The patient can perform the second interactive operation as many times as he/she likes. For each time of the operation, the terminal apparatus screen management unit 42 displays the payment plan 226a with appropriate changes on the interactive screen for agent 211b (FIG. 11) and the interactive screen for patient 251b (FIG. 12).

The second interactive operation in preparing the payment plan 226a of the evaluation target period has been described above. In preparing the annual payment plan 226b, the terminal apparatus screen management unit 42 similarly performs the second interactive operation.

In step S320, the terminal apparatus screen management unit 42 creates and displays a family payment screen. More specifically, firstly, the terminal apparatus screen management unit 42 receives an entry of a past month having already been passed in the year.

Secondly, the terminal apparatus screen management unit 42 extracts one or more records each having a date and time which matches the past month received in the “first” substep of step S320, from among the records in the family payment information 55 (FIG. 7) acquired in the “fifth” substep of step S316.

Thirdly, the terminal apparatus screen management unit 42 sorts the records extracted in the “second” substep of step S320 by the personal ID, to thereby creates the family member-wise category-wise actual paid amount column 273 (FIG. 15).

Fourthly, the terminal apparatus screen management unit 42: collects the records extracted in the “second” substep of step S320; and thereby creates the category-wise pie chart 274 (FIG. 15) which is a pie chart of the amounts paid.

Fifthly, the terminal apparatus screen management unit 42: collects the records extracted in the “second” substep of step S320 by the personal ID; and thereby creates the family member-wise band chart 275 (FIG. 15) which is a band chart of the amounts paid.

Sixthly, the terminal apparatus screen management unit 42 creates the family payment screen 271 (FIG. 15) which contains the family member-wise category-wise actual paid amount column 273, the category-wise pie chart 274, and the family member-wise band chart 275 created in the “third” to “fifth” substeps of step S320, respectively.

Seventhly, the terminal apparatus screen management unit 42: transmits the family payment screen 271 created in the “sixth” substep of step S320 to the patient terminal apparatus 2 and the agent terminal apparatus 3; and displays the screen 271 in the respective output devices 13, 13.

### <Variation>

When the patient or the agent checks a checkbox in the recommendations selection area 225 (see, for example, FIG. 11 and FIG. 12), it is convenient if details and medical effects of a candidate service are also provided.

The terminal apparatus screen management unit 42 may thus: create the service display screen 261 (FIG. 14) in the “third” substep of step S314; transmit the screen 261 to the patient terminal apparatus 2 and the agent terminal apparatus 3; and display the screen 261 in the respective output devices 13, 13. Upon receipt of any one of the service category selection tags 265a to 265f from the patient or the agent, the terminal apparatus screen management unit 42: searches the service information 54 using the received service category as a search key; and acquires the hit record.

The terminal apparatus screen management unit 42 arranges the acquired records based on the priority orders of the selection priority (column 108 in FIG. 3). The terminal apparatus screen management unit 42: creates the service candidate display fields 267, 268, and the like based on the arranged records; transmits the fields 267, 268, and the like to the patient terminal apparatus 2 and the agent terminal apparatus 3; and displays the fields 267, 268, and the like in the respective output devices 13, 13. How the terminal apparatus screen management unit 42 creates the health value fields 264, 267d, 268d is as described above.

Description above is made assuming that payment of medical expenses or the like is displayed on a basis of a calendar year from January through December. The payment may be instead displayed based on, for example, a fiscal year such as from April to March next year, or a year from four months ago to eight months earlier counting from a present date. Further, the payment may be displayed on a basis of “week”, “quarter”, or the like.

### Advantageous Effects of Embodiment

Some advantageous effects of the present embodiment include as follows.

(1) The patient can select a desired candidate service for improving a health value about which the patient himself is concerned, after knowing a medical effect and a cost of the candidate service in a visual manner. Also, the patient can set priority orders among “cost”, “period”, and “effect” on a treatment plan as he/she likes, and, in accordance with the set priority orders, see the candidate service.

(2) The patient can know a result of comparison between a cost of the treatment plan and a target cost amount by the family in a target period in a visual manner.

(3) The patient can compare effects of a plurality of candidate treatment plans in time series.

(4) The patient can see that, in response to an on-screen interactive operation, a set of candidate services with their associated different effects and costs is dynamically changed to another.

(5) The patient can specify a service category and a medical service department as he/she likes, and, in accordance with the selection, see a candidate service.

(6) The patient can look at and hear an image and a voice of the agent in real time.

The present invention is carried out not only by the above-described embodiment but also by various variations. For example, the above-described embodiment is intended to be illustrative of the present invention in an easily understandable manner and the present invention is not limited to that includes all of the components explained in the embodiment. Part of a configuration of an example of the present invention may be substituted by or added to that of another example. Part of a configuration of an example may be deleted.

Part or all of a configuration, a feature, a processing part, a processing unit, or the like may be embodied by hardware by means of, for example, designing using integrated circuits. The above-described configuration, feature, or the like may be embodied by software in which, for example, a processor interprets and executes a program which realizes the feature. Data of a program, a table, a file, and the like for realizing such a feature can be stored in a storage device including a memory, a hard disk, and a SSD (Solid State Drive) or in a storage medium including an IC card, an SD card, and a DVD.

In the present invention, only a control line and an information line which are deemed necessary for explanation are illustrated, and not all of them which may be necessary as a product are illustrated. In practice, almost all units are connected to each other.

1. An interactive health management apparatus, comprising:
a storage unit configured to store therein
health information on one or more time series health values of a patient, the health values stored by category,
medication information on a medication and a price thereof stored in association with the medication, the medication information being acquired from a supporter such as a doctor or provided with control from the supporter,
service information on a service, stored therein, in association with the service, the category of the health value, a degree of improvement with respect to the health value, a period of the service after which an effect of the service is expected; and
a control unit configured to
receive the category of the health value from a terminal apparatus operated by the patient, the degree of improvement in the service information, and priority orders between the period and the price,
search the medication information based on an actual prescription of the patient and acquire one or more candidate medications,
search the service information based on the received health value category and priority orders and acquire one or more candidate services,
display the acquired candidate medications and prices thereof, and the acquired candidate services and fees thereof, in the terminal apparatus,
calculate an estimated value of a health value in the received health value category, based on the degrees of improvement of the displayed candidate services and a past actual value in the health information,
creates a time series graphic based on the calculated estimated health value and displays the created time series graphic in the terminal apparatus, and
receive an instruction on which service of the displayed candidate services is selected via the terminal apparatus from the patient.

2. The interactive health management apparatus according to claim 1,
wherein the storage unit is configured to store therein family information on a family to which the patient belongs, the family information stored in association with the patient, and
wherein the control unit is configured to
receive a medical expense payment budget of the family from the terminal apparatus,
add up the prices of the displayed medications and the fees of the selected services for the family, and
display a ratio of the added up total amount to the received budget in form of a graphic representing the ratio, in the terminal apparatus.

3. The interactive health management apparatus according to claim 2,
wherein the control unit is configured to create a first time series graphic based on the acquired candidate medications and a second time series graphic based on the acquired candidate medications and services, and display the first and second time series graphics on using same axes of coordinates.

4. The interactive health management apparatus according to claim 3,
wherein the control unit is configured to repeatedly perform:
receiving an operation performed to the time series graphic on an outputs screen of the terminal apparatus by the patient;
arranging, in response to the received operation, all records in the service information in order of the degree of improvement, omitting a highly or lowly prioritized record, rearranging the remaining records in order of the period, and further omitting a highly or lowly prioritized record, to thereby acquire the further remaining candidate services; and
displaying the acquired candidate medications and the prices thereof and the acquired candidate services and the fees thereof, in the terminal apparatus, calculating an estimated health value of a health value in the received health value category, based on the degrees of improvement of the displayed candidate services and a past actual value in the health information, and displaying the estimated health value as a time series graphic, in the terminal apparatus.

5. The interactive health management apparatus according to claim 4,
wherein the service information is configured to store therein, in association with the service, a medical service department relevant to the service and the service category,
wherein the control unit is configured to
receive the service category and the medical service department from the terminal apparatus, and
narrow down the records in the service information, using the received service category and medical service department.

6. The interactive health management apparatus according to claim 5,
wherein the control unit is configured to repeatedly perform:
receiving an operation performed to the graphic representing the ratio on the output screen of the terminal apparatus, from the patient; and
arranging, in response to the received operation, the records in the service information in order of the price, omitting a highly or lowly prioritized record, to thereby acquire the remaining candidate services, and displaying a ratio of the added up total amount to the received budget in form of a graphic representing the ratio, in the terminal apparatus.

7. The interactive health management apparatus according to claim 6,
wherein the terminal apparatus includes a first terminal apparatus operated by the patient and a second terminal apparatus operated by an agent who has an interactive conversation with the agent,
wherein the control unit is configured to: establish communications between the first terminal apparatus and the second terminal apparatus; transmit an image and a voice of the patient to the second terminal apparatus; and transmit an image and a voice of the agent to the first terminal apparatus.

8. An interactive health management method, comprising the steps of:
performed by a storage unit thereof,
storing,
health information on one or more time series health values of a patient, the health values stored by category,
medication information on a medication and a price thereof stored in association with the medication, the medication information being acquired from a supporter such as a doctor or provided with control from the supporter, and
service information on a service, stored therein, in association with the service, the category of the health value, a degree of improvement with respect to the health value, a period of the service after which an effect of the service is expected; and,
performed by a control unit,
receiving the category of the health value from a terminal apparatus operated by the patient, the degree of improvement in the service information, and priority orders between the period and the price,
searching the medication information based on an actual prescription of the patient and acquire one or more candidate medications,
searching the service information based on the received health value category and priority orders and acquire one or more candidate services,
displaying the acquired candidate medications and prices thereof, and the acquired candidate services and fees thereof, in the terminal apparatus,
calculating an estimated value of a health value in the received health value category, based on the degrees of improvement of the displayed candidate services and a past actual value in the health information,
creating a time series graphic based on the calculated estimated health value and displays the created time series graphic in the terminal apparatus, and
receiving an instruction on which service of the displayed candidate services is selected via the terminal apparatus from the patient.

9. An interactive health management program embodied on a non-transitory computer-readable medium, the program for causing a computer serving as an interactive health management apparatus which comprises:
a storage unit configured to store therein
health information on one or more time series health values of a patient, the health values stored by category,
medication information on a medication and a price thereof stored in association with the medication, the medication information being acquired from a supporter such as a doctor or provided with control from the supporter, and
service information on a service, stored therein, in association with the service, the category of the health value, a degree of improvement with respect to the health value, a period of the service after which an effect of the service is expected; and
a control unit configured to
receive the category of the health value from a terminal apparatus operated by the patient, the degree of improvement in the service information, and priority orders between the period and the price,
search the medication information based on an actual prescription of the patient and acquire one or more candidate medications,
search the service information based on the received health value category and priority orders and acquire one or more candidate services,
display the acquired candidate medications and prices thereof, and the acquired candidate services and fees thereof, in the terminal apparatus,
calculate an estimated value of a health value in the received health value category, based on the degrees of improvement of the displayed candidate services and a past actual value in the health information,
creates a time series graphic based on the calculated estimated health value and displays the created time series graphic in the terminal apparatus, and
receive an instruction on which service of the displayed candidate services is selected via the terminal apparatus from the patient.
